(19) United States
(12) Patent Application Publication
(10) Pub. No.: US 2019/0031531 A1
(43) Pub. Date: Jan. 31, 2019

(54) Temperature-Matched Influent Injection in Humidifier Systems and Associated Methods

(71) Applicant: Gradiant Corporation, Woburn, MA (US)

(72) Inventors: Steven Lam, Medford, MA (US); Prakash Narayan Govindan, Melrose, MA (US)

(73) Assignee: Gradiant Corporation, Woburn, MA (US)

(21) Appl. No.: 15/664,585

(22) Filed: Jul. 31, 2017

(51) Int. Cl. C02F 1/04; B01D 3/16; B01D 5/00

(52) U.S. Cl. CPC C02F 1/048; B01D 5/006; B01D 5/003; B01D 3/16

(57) ABSTRACT

Temperature-matching of an injected influent stream with a location along a humidifier feed stream flow path is generally described. According to embodiments, an influent stream can be injected into and combined with a feed stream of a humidifier at a location on the humidifier feed stream flow path at which the temperature of the feed stream most closely matches the temperature of hot influent stream.

### TECHNICAL FIELD

Humidifier systems in which temperature-matched influent injection is employed, and associated methods, are generally described

### BACKGROUND OF THE INVENTION

Increasing demand for fresh water has strained global water resources to the point where over four billion people lack sufficient access to reliable potable water, year-round, as explained, for example, in “Four Billion People Facing Severe Water Scarcity” published 12 Feb. 2016 in Science Advances. Concurrently, the increasing extraction of natural resources strains water supplies and generates wastewater in high volumes. Increased scrutiny on these processes worldwide has increased the demand for wastewater treatment and water management technologies.

The humidification-dehumidification process is well suited to address both problems simultaneously with its capability of producing fresh water from highly contaminated wastewaters, as well as its ability to diminish the volume of those streams by concentrating them to saturation. In this process, a humidifier is used to concentrate wastewater by evaporating water vapor therefrom into a gas stream. The vapor is condensed from the gas stream to produce pure water, and the waste stream from which the water was evaporated becomes concentrated. Unlike most desalination processes, the separation of water from influent occurs at a gas-liquid interface in the humidifier and is thus unhindered by fouling of the separation-surface. The effect of vapor pressure facilitates evaporation at sub-boiling temperatures, further protecting process components from scalants with inverse temperatures solubilities. Additionally, the process is driven largely by thermal energy, allowing integration with industrial processes and operation in remote areas where natural resources are often extracted. However, thermal energy is relatively inefficient to recover, as compared to other driving forces often used in desalination. Thus, the process's reliance on the convenience of thermal energy bounds the energy efficiency of state-of-the-art humidification-dehumidification systems.

Higher levels of thermal integration of humidification technology with industrial processes may be feasible with, for example, industrial processes that generate hot wastewater such as flue gas desulfurization (FGD) and steam-assisted bitumen extraction processes. In these and similar processes, highly contaminated wastewater is produced from condensed steam or the remnants of a process stream exposed to boiling temperatures. The resulting wastewater has a temperature that is relatively hot, but below the waste stream's boiling point. These hot streams can be best utilized by thermal desalination techniques that operate at sub-boiling temperatures, because no additional temperature conditioning is required. However, state of the art humidification-dehumidification is designed for low temperature streams. Improvements to these systems that better utilize influent thermal energy remediate the efficiency deficit resulting from the use of thermal energy are desirable.

### BRIEF SUMMARY OF THE INVENTION

Temperature-matching of an injected influent stream with a location along a humidifier feed stream flow path is generally described. Per certain embodiments, an influent stream can be injected into and combined with a feed stream of a humidifier at a location on the feed stream's flow path at which the temperature of the feed stream most closely matches the temperature of hot influent stream. The subject matter of the present invention involves, in some cases, interrelated products, alternative solutions to a particular problem, and/or a plurality of different uses of one or more systems and/or articles.

Certain aspects relate to methods of evaporating water within a humidifier system. In some embodiments, the method comprises flowing a first liquid stream comprising water and a dissolved salt, the first liquid stream having a first temperature, through a first heating device, wherein the first liquid stream is heated to a second temperature within the first heating device to form a heated liquid stream. Certain embodiments comprise combining the heated liquid stream with a second liquid stream comprising water and a dissolved salt, the second liquid stream having a third temperature, to form a combined liquid stream. According to some embodiments, the combined liquid stream is directly contacted with an influent gas stream within a humidifier to transfer to heat and mass from the combined liquid stream to the influent gas stream, wherein the heat and mass transfer produces a humidified gas stream enriched in water vapor with respect to the influent gas stream. In some such embodiments, the differences between the first temperature and the third temperature is greater in magnitude than the difference between the second temperature and the third temperature.

Some aspects relate to a method of operating a humidifier system. In certain embodiments, the method comprises flowing a first liquid stream comprising water and a dissolved salt into a humidifier feed stream flow path comprising a first heating device, a humidification region of a humidifier, and a plurality of influent injection junctions. In some such embodiments, the plurality of influent injection junctions includes at least a first injection located junction upstream of the first heating device and a second injection junction located upstream of the humidification region of the humidifier and downstream of the first heating device. Certain embodiments comprise heating a fluid comprising the first liquid stream in the first fluidic pathway of the first heat exchanger, wherein the fluid comprising the first liquid stream is heated from a first temperature to a second temperature. In some embodiments, a second liquid stream comprising water and a dissolved salt, is injected into one of the influent injection junctions to form a combined liquid stream comprising the first liquid stream and the second liquid stream. In some such embodiments, at the influent injection junction into which the second liquid stream is injected, the first stream has a temperature that is closer to the temperature of the second liquid stream than that of any other liquid stream entering any other influent injection junction from the humidifier feed stream flow path. Certain embodiments comprise directly contacting the combined liquid stream with an influent gas stream, within the humidification region of the humidifier, to transfer to heat and mass from the combined liquid stream to the influent gas stream, wherein the heat and mass transfer produces a humidified gas stream enriched in water vapor with respect to the influent gas stream.

The methods allow greater utilization of influent thermal energy carried by a feed stream into a humidifier system. This increased utility can be used to reduce required heat transfer area, increase evaporation rates, and/or increase heating efficiency in such systems. For humidification-dehumidification systems to which the methods are applied, the increased utilization of influent thermal energy can increase the recovery of thermal energy and/or condensed water in addition to the advantages listed above. Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

FIG. 1 shows a schematic illustration of an exemplary system comprising a humidifier and a first heating device, and an influent injection junction, according to some embodiments

FIG. 2 shows a schematic illustration of an exemplary system comprising a humidifier, a first heating device, a second heating device, an influent injection junction, and dehumidifier, according to some embodiments

FIG. 3 shows a schematic illustration of an exemplary system comprising a humidifier, a heating device, a second heating device, a dehumidifier, and an influent injection system comprising a plurality of injection junctions, according to some embodiments

### DETAILED DESCRIPTION OF THE INVENTION

Systems and methods for injecting an influent stream into a humidifier feed stream flow path at a temperature-matched influent injection junction are generally described. Certain embodiments comprise injecting an influent stream comprising a condensable fluid in liquid phase (e.g. water) and a dissolved salt (e.g. sodium chloride) into a humidifier system to combine with a liquid feed stream comprising a condensable fluid in liquid phase and a dissolved salt, the combination of the streams occurring after heating the feed stream in a first heating device, and before transferring heat and mass from the combined liquid stream to a non-condensable gas stream (e.g. air) in a humidification zone within a humidifier. According to some embodiments, the injected influent stream has a temperature that is closer to the temperature of the feed stream after being heated in the first heating device than the temperature of the feed stream prior to any heating. According to some embodiments, the temperature of the injected influent stream is substantially closer to the temperature of the feed stream immediately upstream of the injection junction than to the temperature the feed stream, or a stream comprising the feed stream, at any other location along the humidifier feed stream flow path.

Some embodiments comprise a plurality of selectable injection junctions, and influent injection system fluidically connected the plurality of injection junctions and configured to inject the influent stream into a selected injection junction to combine with the feed stream. Per certain embodiments, the injection junction is selected such that the temperature of the influent stream is closest to the temperature of the feed stream immediately entering selected injection junction.

According to some embodiments, temperature-matched influent injection may yield certain advantages over state-of-the art humidification systems in which the influent is introduced upstream of any heating devices. For example, the heating device(s) may perform more efficiently due to the comparatively smaller rate of fluid affected by the heat transfer, according to some embodiments. In certain embodiments, the rate of evaporation in the humidifier may be increased. According to certain embodiments comprising an influent injection system, the effect of temperature variation in the influent liquid stream on the steady state conditions of the humidifier system may be mitigated.

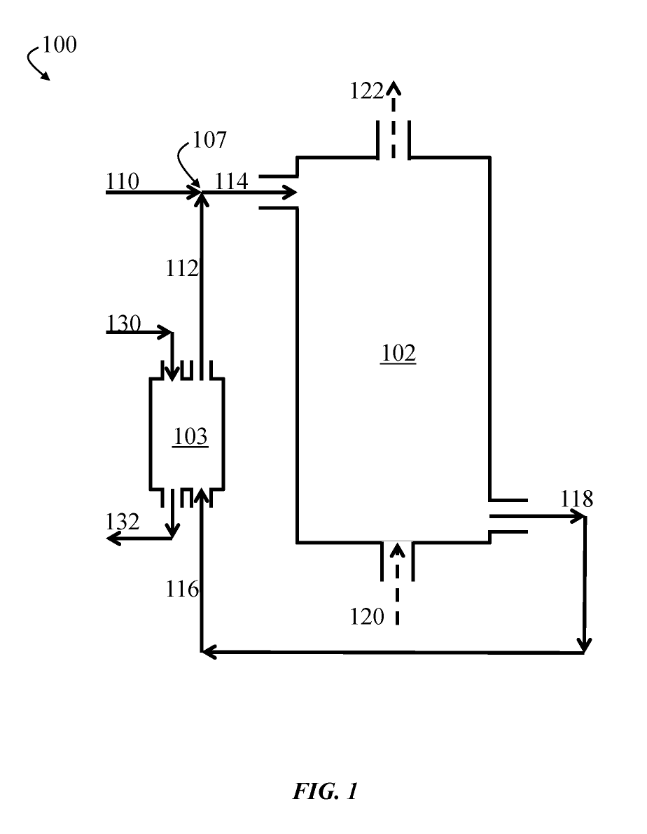

FIG. 1 is an exemplary schematic illustration of a humidifier system 100 in which an influent stream is injected downstream of a first heating device. The humidifier system 100 comprises humidifier 102, first heating device 103, and injection junction 107. Humidifier 103 comprises a liquid inlet, shown in FIG. 1 as the inlet receiving stream 114, which is fluidically connected to and/or comprises influent injection junction 107. Humidifier 103 additionally comprises the following ports: a gas inlet, shown in the figure as inlet receiving stream 120; a liquid outlet, shown as transmitting stream 118, and a gas outlet, shown as transmitting stream 122. First heating device 102 is fluidically connected to influent injection junction 107 via a first fluidic pathway outlet, shown in FIG. 1 as transmitting stream 112. The first fluidic pathway outlet is fluidically connected to a first fluidic pathway inlet, which is shown as receiving stream 116. First heating device 103 may also comprise an optional second fluidic pathway inlet fluidically connected to an optional second fluidic pathway outlet, shown as transmitting streams 130 and 132, respectively.

In operation, first heating device 103 may receive a heating influent stream 130, having a relatively high temperature. Within heating device 130, heat may be transferred from the heating influent stream 130 to a feed stream 116, comprising a condensable fluid in liquid phase and a dissolved salt, to produce a cooled heating stream 132 from the heating influent stream 130 and, from the feed stream 116, a heated stream 112, which may then be directed to influent injection junction 107. According to certain embodiments, an influent stream 110 may be injected into influent injection junction 107 to combine with the heated feed stream 112, resulting in a combined liquid stream 114. In some such embodiments, injected influent stream 110 has a temperature that is relatively close to the temperature of the heated feed stream 112 (e.g. closer in temperature to the heated feed stream 112 than to feed stream 116). Downstream of the injection junction, the combined liquid stream 114 may enter the humidifier 102, within which it may contact an influent gas stream 120, which may comprise a non-condensable gas.

According to some embodiments, the temperature of the combined liquid stream 114 is greater than the temperature of the influent gas stream 120. In such embodiments, the contact between the combined liquid stream 114 and the influent gas stream 120 may result in the transfer of sensible heat and latent heat in the form of condensable fluid vapor between the combined liquid stream 114 and the influent gas stream 120. In some cases, the effect of vapor pressure can facilitate the evaporation of condensable fluid from the combined liquid stream into the influent gas stream 120 at temperatures below the boiling point of the condensable fluid. In some embodiments, the hotter temperature of the combined liquid stream 114 with respect to the influent gas stream 120 can result in transfer of sensible heat from the combined liquid stream 114 to the influent gas stream 120. The transfer of heat and condensable fluid vapor to the influent air stream can heat the influent gas stream 120 and humidify it with condensable fluid vapor, producing a humidified gas stream 122, which may exit the humidifier through its gas outlet. The same transfer can simultaneously cool and concentrate the combined liquid stream 114 to produce a concentrate stream 118.

In certain embodiments, at least a portion of the concentrate stream 118 may be recirculated such that feed stream 116 comprises the at least a portion of the concentrate stream. In the embodiment shown in FIG. 1, the entirety of concentrate stream 118 is recirculated. In other embodiments, at least a portion of the concentrate stream 118 may be discharged from the humidifier system 100. In some embodiments, at least a portion of concentrate stream 118 may recirculated as a recirculation stream and another portion may be discharged from the system to maintain a steady-state salinity in an active system volume comprising the recirculation stream, the feed stream, the combined liquid stream, liquid within the humidifier, and the concentrate stream prior to discharge. In certain cases, the discharge and/or recirculation of stream 118 is controlled such that a steady-state volume of liquid is maintained in the active system volume. In other cases, the active system volume and its salinity is controlled to fluctuate.

The influent injection junction may be of any configuration suitable for combining an injected influent stream with a feed stream. In some embodiments, the influent injection junction comprises a three-way junction (e.g. a tee fitting) between pipes or conduits feeding the injection junction. The injection junction may comprise features to increase mixing between the injected influent stream and the feed stream such as an in-line static mixer, a mixing tank, or a series of angles in the piping or conduit (e.g. elbow fittings). While the embodiment depicted in FIG. 1 shows influent injection junction 107 as separated from first heating device 103 and humidifier 102, alternative embodiments comprise an influent injection junction that is directly coupled with one or more system components. For example, the influent injection junction 107 may be directly coupled to the first fluidic pathway outlet of the first heating device. In other embodiments, the injection junction is integrated with the humidifier. For example, the humidifier may comprise a liquid distribution system, as explained in more detail later, such as a V-notch weir liquid distributor configured to distribute the combined fluid evenly across the humidification zone in which the combined liquid contacts a gas stream. The liquid distributor may receive the feed liquid and the injected liquid from two separate sources, the two liquids mixing within the distributor to form a combined liquid stream, before the combined liquid stream is evenly distributed into the humidification zone. Per other embodiments, the injection junction is coupled with the boundary of the humidification zone. For example, the injected influent stream and the feed stream may be separately fed to the humidification zone via separate liquid distributors, such that they cross the boundary of the humidification zone simultaneously at same location, resulting in a combined liquid stream entering the humidification zone.

In some embodiments, the injected influent stream has a temperature that is close to the temperature of a feed stream entering the injection junction. For example, the temperature of injected influent stream 110 may be close to the temperature of heated feed stream 112 entering influent injection junction 107. According to embodiments in which the feed stream is heated upstream of the influent injection junction, the injected influent stream has a relatively high temperature before entering the humidifier system. In some such embodiments, the high temperature of the injected influent stream may characteristic of the source of the influent stream.

The injected influent stream can originate from a variety of sources. For example, in certain embodiments, at least a portion of the injected stream comprises and/or is derived from wastewater produced from industrial processes in which steam is produced or condensed at ambient pressure. Examples of such processes include flue gas desulfurization, and steam-assisted oil extraction. Wastewaters from processes such as these typically have temperatures close to the boiling point of water, particularly wherein the wastewaters derive from a stream that comprises condensed stream and/or comprises the remnants of a stream concentrated by boiling.

The temperature of injected influent stream is, according to certain embodiments, relatively close to the boiling point of water. For example, the temperature of the injected influent stream may be at least about 80° C. [176° F.], at least about 90° C. [194° F.], at least about 100° C. [210° F.], or, in some cases, at least about the boiling point of the injected influent stream at ambient pressure. In some embodiments, the temperature of the injected influent stream may be in the range of about 80° C. [176° F.] to about 90° C. [194° F.], about 90° C. [194° F.] to about 100° C. [210° F.], or, in certain embodiments, about 100° C. [210° F.] to about the boiling point of the injected influent stream at ambient pressure.

In other embodiments, the temperature of the injected influent stream is relatively close to the dew point of humid air that is in vapor-liquid equilibrium with 95° C. [203° F.] saline water with a saturated concentration of sodium chloride. As will be explained in more detail later, this temperature may be particularly beneficial when applied to a humidifier system that is a sub-component of a humidifier-dehumidifier system. Certain embodiments comprise injected influent streams with temperatures of at least about 50° C. [132° F.], at least about 60° C. [140° F.], at least about 70° C. [158° F.], or at least about 80° C. [176° F.]. In some embodiments, the temperature of the injected influent stream may be at in the range of about 50° C. [132° F.] to about 60° C. [140° F.], about 60° C. [140° F.] to about 70° C. [158° F.], or about 70° C. [158° F.] to about 80° C. [176° F.].

In certain embodiments, the system can be configured to receive an injected influent stream at a relatively high rate. Without wishing to be bound to a particular theory, it is believed that the efficient utilization of influent thermal energy via temperature-matched influent injection can result is improved rates of evaporation, which in turn may require an increased influent rate. In some embodiments, the flow rate of the injected influent stream may be about 10 L/min [2.6 gallons/minute (gpm)], about 50 L/min [13 gpm], about 100 L/min [26 gpm], about 500 L/min [130 gpm], about 1,000 L/min [260 gpm], about 5,000 L/min [1,300 gpm], or in some cases, about 10,000 L/min [2,600 gpm]. Certain embodiments comprise influent injection flow rates in the range of about 10 L/min [2.6 gpm] to about 100 L/min [26 gpm], about 100 L/min [26 gpm] to about 1,000 L/min [260 gpm], about 1,000 L/min [260 gpm] to about 10,000 L/min [2,600 gpm].

In some embodiments, the injected influent stream has a relatively high salinity. The salinity of a solution is generally defined the mass of all dissolved salts per unit volume of solution divided by the density of the solution. In some cases, the salinity of the injected influent stream is at least about 5%, at least about 10%, at least about 15%, at least about 20%, or least about 25% (and/or, in certain cases, up to the solubility limit of one or more of the dissolved salts in the injected influent stream). In some embodiments, the injected influent stream has a salinity in the range of about 5% to about 10%, about 5% to about 15%, about 5% to about 20%, about 5% to about 25%, about 10% to about 15%, about 10% to about 20%, about 10% to about 25%, about 15% to about 20%, about 25% to about 25%, or about 20% to about 25%. The salinity in a stream can be measured by filtering a well-mixed sample through a standard glass-fiber filter, evaporating the filtrate to dryness in a weighed dish at 180° C., then measuring the increase in weight of the dish. The increase in weight is divided by the weight of the sample before drying, yielding the salinity of the sample.

In some embodiments, the humidifier system comprises a humidifier feed stream flow path. The humidifier feed stream flow path may be fluidically connected to a source of feed stream at one end and a humidification zone of a humidifier at the opposite end, and comprises all conduits and system components wettable by fluid flowing from said source to the humidification zone. For example, in FIG. 1, humidifier system 100 comprises a humidifier feed stream flow path comprising the conduit conveying stream 116, components of heating device 103 wettable by stream 116 (e.g. a first fluidic pathway inlet of heating device 103, a first fluidic pathway, and a first fluidic pathway outlet), the conduit conveying stream 112, influent injection junction 107, the conduit conveying stream 114, and components of humidifier 102 wettable by stream 116 and upstream of the humidification zone (e.g. a liquid inlet, a liquid distributor, and the boundary of the humidification zone). The humidifier feed stream flow path is configured, according to certain embodiments, to convey a feed stream and/or a liquid comprising the feed stream, from a source of the feed stream to the humidification zone of the humidifier. In some embodiments, the humidifier flow path comprises one or more injection junctions.

The injected influent may be combined in an injection junction with a feed stream flowing along the humidifier feed stream flow path. The temperature of the feed stream may be changed at one more locations along the humidifier feed stream flow path prior to its combination with the injected influent. The temperature of the combined stream may be changed one or more times as well, as it flows from the injection junction to the humidification zone, along the humidifier feed stream flow path. Some embodiments comprise one or more heating devices located along the humidifier feed stream flow path for changing the temperature of the stream flowing therein. According to certain embodiments, the influent injection junction is located on the humidification feed stream flow path at a position downstream of one or more of the heating devices such that the influent is combined with a heated feed stream. In some such embodiments, the temperature of the feed stream at the injection junction may be closer the temperature of the injected influent stream than the temperature of the feed stream prior to any heating. In some embodiments, the temperature of the feed stream at the injection junction is substantially closer to the temperature of the injected influent stream than the temperature of the feed stream (or a stream comprising the feed stream) at any other location along the humidifier flow path.

According to some embodiments the temperature of the feed stream entering the injection junction into which the influent stream is injected is relatively close to the temperature of the injected influent. For example, the difference in magnitude between the temperature of feed stream entering the injection junction into which the influent stream is injected and the temperature of the injected influent stream may be less than about 30° C. [54° F.], less than about 20° C. [36° F.], less than about 15° C. [27° F.], less than about 10° C. [18° F.], less than about 5° C. [9° F.], less than about 2° C. [3.6° F.], less than about 1° C. [1.8° F.]. In some cases, the injected influent stream may be substantially the same temperature as the feed stream entering the influent injection junction.

In certain embodiments, the temperature of the injected influent is substantially greater than the temperature of the feed stream prior to any heating. For example, the temperature of the injected influent stream may be greater than the temperature of the feed stream by more than about 10° C. [18° F.], by more than about 15° C. [27° F.], by more than about 20° C. [36° F.], by more than about 30° C. [54° F.], by more than about 40° C. [72° F.], by more than about 50° C. [90° F.], by more than about 75° C. [135° F.], or in some extreme cases, by more than about 100° C. [180° C.]. In some embodiments, the temperature of the injected influent stream may be greater than the temperature than the temperature of the feed stream prior to any heating by about by about 10° C. [18° F.] to about 15° C. [27° F.], about 15° C. [27° F.] to about 30° C. [54° F.], about 30° C. [54° F.] to about 50° C. [90° F.], about 50° C. [90° F.] to about 75° C. [135° F.], about 75° C. [135° F.] to about 100° C. [180° F.].

In some embodiments, the temperature of the injected influent stream is substantially closer to the temperature of the feed stream entering the injection junction into which the influent stream is injected the than the temperature of the feed stream entering the first heating device. For example, the difference in magnitude between the temperature of the injected influent stream and the temperature of the feed stream entering the injection junction into which the influent stream is injected may be smaller than the difference in magnitude between the temperature of the injected influent stream and the temperature of the feed stream entering the first heating device by at least about 50° C. [90° F.], at least about 40° C. [72° F.], at least about 30° C. [54° F.], at least about 20° C. [36° F.], at least about 15° C. [27° F.], at least about 10° C. [18° F.], and/or at least about 5° C. [9° F.]. In some cases the difference in magnitude between the temperature of the injected influent stream and the temperature of the feed stream entering the injection junction into which the influent stream is injected may be smaller than the difference in magnitude between the temperature of the injected influent and the temperature of the feed stream entering the first heating device by about 50° C. [90° F.] to about 30° C. [54° F.], by about 40° C. [72° F.] to about 20° C. [36° F.], by about 30° C. [54° F.] to about 10° C. [18° F.], or about to 15° C. [27° F.] to about 5° C. [9° F.].

The first heating device may be any device that is capable of transferring heat to a fluid stream. In some embodiments, the first heating device comprises a first fluidic pathway. In certain cases, the first heating device comprises a first fluidic pathway inlet and a first fluidic pathway outlet. The first fluidic pathway inlet of the heating device may be a liquid inlet of the first fluidic pathway, and the first fluidic pathway outlet of the heating device may be a liquid outlet of the first fluidic pathway. In some embodiments, the first fluidic pathway inlet of the heating device is fluidically connected to a source of a feed stream comprising a condensable fluid in liquid phase and a dissolved salt. In other embodiments, the first fluidic pathway inlet of the first heating device is fluidically connected to an outlet of a second heating device. In certain embodiments, the first fluidic pathway outlet of the first heating device comprises or is fluidically connected to an influent injection junction. In some embodiments, the first fluidic pathway outlet of the first heating device is fluidically connected to an inlet of a combined stream heating device.

In some embodiments, the first heating device is a heat exchanger. The first heating device may be any type of heat exchanger known in the art. In some cases, the heat exchanger comprises a first fluidic pathway and a second fluidic pathway. A first fluid stream may flow through the first fluidic pathway, and a second fluid stream may flow through the second fluidic pathway. The first fluid stream and the second fluid stream may be in direct or indirect contact, and heat may be transferred between the first fluid stream and the second fluid stream. In some embodiments, the first fluid stream and the second fluid stream are only in indirect contact. In certain embodiments, the second fluid stream comprises a heating fluid. The heating fluid may be any fluid capable of absorbing and transferring heat. Non-limiting examples of suitable heating fluids include water, air, saturated/superheated steam, synthetic organic-based non-aqueous fluids, glycol, brines, and/or mineral oils.

In some embodiments, a first fluid stream flows through the first fluidic pathway in a first direction, and a second fluid stream flows through the second fluidic pathway in a second direction that is substantially opposite from the first direction (e.g., counter flow), substantially the same as the first direction (e.g., parallel flow), or substantially perpendicular to the first direction (e.g., cross flow). In certain cases, a counter-flow heat exchanger may be more efficient than other types of heat exchangers. In some embodiments, the first heating device is a counter-flow heat exchanger. In some embodiments, more than two fluid streams may flow through the heat exchanger.

In some embodiments, the first fluid stream flowing through the first fluidic pathway of the first heating device and/or the second fluid stream flowing through the second fluidic pathway of the first heating device are liquid streams, and the first heating device is a liquid-to-liquid heat exchanger. In other embodiments, the first fluid stream flowing through the first fluidic pathway of the first heating device and/or the second fluid stream flowing through the second fluidic pathway of the first heating device are gas streams. In some embodiments, the first fluid stream and/or second fluid stream do not undergo a phase change (e.g., liquid to gas or vice versa) within the heating device.

Examples of suitable heat exchangers include, but are not limited to, plate-and-frame heat exchangers, shell-and-tube heat exchangers, tube-and-tube heat exchangers, plate heat exchangers, plate-and-shell heat exchangers, and the like. In a particular, non-limiting embodiment, the first heating device is a plate-and-frame heat exchanger.

In some embodiments, the first heating device may exhibit relatively high heat transfer rates. In some embodiments, the first heating device may have a heat transfer coefficient of at least about 150 W/(m2 K), at least about 200 W/(m2 K), at least about 500 W/(m2 K), at least about 1000 W/(m2 K), at least about 2000 W/(m2 K), at least about 3000 W/(m2 K), at least about 4000 W/(m2 K), at least about 5000 W/(m2 K), at least about 6000 W/(m2 K), at least about 7000 W/(m2 K), at least about 8000 W/(m2 K), at least about 9000 W/(m2 K), or at least about 10,000 W/(m2 K). In some embodiments, the first heating device may have a heat transfer coefficient in the range of about 150 W/(m2 K) to about 10,000 W/(m2 K), about 200 W/(m2 K) to about 10,000 W/(m2 K), about 500 W/(m2 K) to about 10,000 W/(m2 K), about 1000 W/(m2 K) to about 10,000 W/(m2 K), about 2000 W/(m2 K) to about 10,000 W/(m2 K), about 3000 W/(m2 K) to about 10,000 W/(m2 K), about 4000 W/(m2 K) to about 10,000 W/(m2 K), about 5000 W/(m2 K) to about 10,000 W/(m2 K), about 6000 W/(m2 K) to about 10,000 W/(m2 K), about 7000 W/(m2 K) to about 10,000 W/(m2 K), about 8000 W/(m2 K) to about 10,000 W/(m2 K), or about 9000 W/(m2 K) to about 10,000 W/(m2 K).

In some embodiments, the first heating device is a heat exchanger is configured transfer heat from a heating fluid, wherein the heat is generated by or recovered from a heat source separated from the heating device. In certain cases, the heat source is a boiler. For example, the boiler may be configured to heat a heating fluid stream (e.g. the heating influent stream), and the heat exchanger may be configured to receive the heating fluid stream and transfer heat from it. In other cases, the heat source is a system exterior to the humidifier system, such as a cooling jacket for a diesel engine. For example, the cooling jacket may be configured to transfer heat produced by the diesel engine to the heating fluid stream, and the heat exchanger may be configured to receive the heating fluid stream and transfer heat from it. In some cases, the heat source is another system comprising a humidifier, such as a humidifier-dehumidifier system. As will be explained in more detail later on, a dehumidifier in the humidifier-dehumidifier system may be configured to transfer heat recovered from a humidification-dehumidification process to a fluid stream, and the heat exchanger may be configured to receive the fluid stream and transfer heat from it. In certain cases, a humidifier-dehumidifier system comprises a humidifier system that includes the first heating device, and a dehumidifier that is the heat source for the first heating device.

In some embodiments, the first heating device is a heat collection device. The heat collection device may be configured to produce and/or store and/or utilize thermal energy (e.g., in the form of combustion of natural gas, solar energy, waste heat from a power plant, or waste heat from combusted exhaust). In certain cases, the first heating device is configured to convert electrical energy to thermal energy. For example, the first heating device may be an electric heater. In some embodiments, the first heating device comprises a furnace (e.g., a combustion furnace).

The first heating device may, in some cases, increase the temperature of one or more fluid streams flowing through (or otherwise in contact with) it. For example, the difference between the temperature of a fluid stream exiting the heating device and the fluid stream entering the first heating device may be at least about 5° C. [9° F.], at least about 10° C. [18° F.], at least about 15° C. [27° F.], at least about 20° C. [36° F.], at least about 30° C. [54° F.], at least about 40° C. [72° F.], or at least about 50° C. [90° F.]. In some embodiments, the difference between the temperature of a fluid stream entering the first heating device and the fluid stream first exiting the heating device may be in the range of about 5° C. [9° F.] to about 10° C. [18° F.], about 5° C. [9° F.] to about 15° C. [27° F.], about 5° C. [9° F.] to about 20° C. [36° F.], about 5° C. [9° F.] to about 30° C. [54° F.], about 5° C. [9° F.] to about 40° C. [72° F.], about 5° C. [9° F.] to about 50° C. [90° F.], about 10° C. [18° F.] to about 20° C. [36° F.], about 10° C. [18° F.] to about 30° C. [54° F.], about 10° C. [18° F.] to about 40° C. [72° F.], about 10° C. [18° F.] to about 50° C. [90° F.], about 20° C. [36° F.] to about 30° C. [54° F.], about 20° C. [36° F.] to about 40° C. [72° F.], or about 20° C. [36° F.] to about 50° C. [90° F.]. In some cases, the temperature of a fluid stream (e.g., a feed stream) being heated in the first heating device remains below the boiling point of the fluid stream.

The first heating device, in certain embodiments, heats one or more fluid streams flowing through (or otherwise in contact with) it to a temperature that is relatively close to the dew point of humid air that is in vapor-liquid equilibrium with 95° C. [203° F.] saline water with a saturated concentration of sodium chloride. For example, the first heating device can heat a fluid stream to least about 50° C. [132° F.], at least about 60° C. [140° F.], at least about 70° C. [158° F.], or to at least about 80° C. [176° F.]. In some embodiments, the first heating device can heat a fluid stream to a temperature in the range of about 50° C. [140° F.] to about 60° C. [140° F.], about 60° C. [140° F.] to about 70° C. [158° F.], or about 70° C. [158° F.] to about 80° C. [176° F.].

The first heating device, in certain embodiments, heats one or more liquid streams flowing through (or otherwise in contact with) it to a temperature that is relatively to the boiling point of the liquid stream. For example, the first heating device can heat a liquid stream to least about 80° C. [176° F.], at least about 90° C. [194° F.], at least about 100° C. [210° F.], or, in some cases, at least about the boiling point of the liquid stream. In some embodiments, the first heating device can heat a liquid stream to a temperature in the range of about 80° C. [176° F.] to about 90° C. [194° F.], about 90° C. [194° F.] to about 100° C. [210° F.], or, in certain embodiments, about 100° C. [210° F.] to about the boiling point of the liquid stream.

In some embodiments, the first heating device utilizes low-grade heat (e.g., heat having a temperature of about 90° C. or less) to increase the temperature of the fluid stream. In certain cases, for example, low-grade heat may be obtained from industrial processes, cogeneration plants, geothermal heat sources, solar radiation, combustion engines (e.g., diesel engine cooling jackets), power plant cooling water, oil refineries, metallurgy processes (e.g., titanium refining), and/or conventional heat sources.

The humidifier may be any type of humidifier known in the art. In some embodiments, the humidifier is configured to receive a liquid stream comprising a condensable fluid in liquid phase and a dissolved salt (e.g., a combined liquid stream received from the heating device). In some embodiments, the humidifier is also configured to receive a gas stream via at least one humidifier gas inlet. In some cases, the gas comprises at least one non-condensable gas. A non-condensable gas generally refers to a gas that cannot be condensed from gas phase to liquid phase under the operating conditions of the humidifier. Examples of suitable non-condensable gases include, but are not limited to, air, nitrogen, oxygen, helium, argon, carbon monoxide, carbon dioxide, sulfur oxides (SOx) (e.g., SO2, SO3), nitrogen oxides (NOx) (e.g., NO, NO2), and/or a combination thereof. In some embodiments, the gas is a gas mixture (e.g., the gas comprises at least one non-condensable gas and one or more additional gases).

The humidifier may comprise a humidification zone in which the gas stream comes into contact (e.g., direct or indirect contact) with the combined liquid stream. In some embodiments, the temperature of the combined liquid stream is higher than the temperature of the gas stream. According to some embodiments, upon contact of the gas stream and the combined liquid stream within the humidification zone, an amount of heat and at least a portion of the condensable fluid in the liquid are transferred from the combined liquid stream to the gas stream via an evaporation (e.g., humidification) process, thereby producing a vapor-containing humidified gas stream and a cooled concentrate stream. In some embodiments, the vapor-containing humidified gas stream comprises a vapor mixture (e.g., a mixture of the condensable fluid in vapor phase and the non-condensable gas). In certain cases, the condensable fluid is water, and the humidified gas stream is enriched in water vapor relative to the gas stream received from the main humidifier gas inlet. In some embodiments, the cooled concentrate stream has a higher concentration of the dissolved salt than the combined liquid stream (e.g., the cooled concentrate stream is enriched in the dissolved salt relative to the combined liquid stream).

In some embodiments, the humidifier is configured such that a liquid inlet is positioned at a first end (e.g., a top end) of the humidifier, and a gas inlet is positioned at a second, opposite end (e.g., a bottom end) of the humidifier. The humidifier may also comprise a liquid outlet at the second end of the humidifier and a main gas outlet at the first end of the humidifier. Such a configuration may facilitate the flow of a liquid stream (e.g., the combined liquid stream) in a first direction through the humidifier from the main liquid inlet to the main liquid outlet and the flow of a gas stream in a second, substantially opposite direction through the humidifier from the gas inlet to the main gas outlet, which may advantageously result in high thermal efficiency. In addition, the humidifier may comprise at least one intermediate humidifier gas outlet.

In some embodiments, the humidifier is configured to facilitate direct contact between a liquid stream (e.g., the combined liquid stream) and a gas stream. In some embodiments, the direct contact occurs in the humidification zone of the humidifier. For example, the humidifier may be configured to provide or create a large interfacial area within the humidification zone across which the liquid stream and the gas stream can directly interact. According to certain embodiments, the humidifier contains a packing material that affects the flow of one or more of the fluid streams through the humidifier. For example, the liquid stream may wet the packing material to form thin films. In other cases, the humidifier may be configured to create droplets of liquid dispersed in the gas or bubbles of gas dispersed in the liquid. The large interfacial area can increase the rate of heat and mass transfer between the two fluids.

In certain embodiments, the humidifier comprises one or more optional droplet eliminators. A droplet eliminator generally refers to a device or structure configured to prevent entrainment of liquid droplets. Non-limiting examples of suitable types of droplet eliminators include mesh eliminators (e.g., wire mesh mist eliminators), vane eliminators (e.g., vertical flow chevron vane mist eliminators, horizontal flow chevron vane mist eliminators), cyclonic separators, vortex separators, droplet coalescers, and/or knockout drums. In some cases, the droplet eliminator may be configured such that liquid droplets entrained in a gas stream collide with a portion of the droplet eliminator and fall out of the gas stream. In certain embodiments, the droplet eliminator may extend across one or more gas outlets of a humidifier. In some cases, a droplet eliminator may be positioned within a humidifier, a humidification zone, a gas outlet, and/or within a conduit directly fluidically connected to, and downstream of, a gas outlet. In some cases, reducing or eliminating droplet entrainment may advantageously increase the amount of condensable fluid in liquid phase (e.g., purified water) evaporated from a humidifier (e.g., by reducing the amount of condensable fluid lost through a gas outlet).

In some embodiments, the humidifier further comprises a gas distribution chamber positioned between the humidifier gas inlet and the humidification zone. In certain embodiments, the gas distribution chamber is positioned at or near the bottom portion of the humidifier. In some embodiments, the gas distribution chamber comprises or is fluidically connected (e.g., directly fluidically connected) to the humidifier gas inlet. The gas distribution chamber may have sufficient volume to allow a gas stream (e.g., a gas stream comprising a non-condensable gas) to substantially evenly diffuse over the cross section of the humidifier. The gas distribution chamber may comprise features to increase the even distribution of gas over the cross-sectional plane perpendicular to the gas flow. For example, the gas distribution chamber may comprise one or more baffles. In some embodiments, the gas distribution chamber comprises a gas inlet diffuser configured to diffuse the momentum of influent gas. Non-limiting examples of suitable inlet diffusers include sparger pipes, vapor horns, lateral arm diffusers, and vane-type diffusers.

In some cases, the gas distribution chamber further comprises a liquid layer (e.g., a liquid sump volume). For example, liquid (e.g., comprising the condensable fluid in liquid phase and a dissolved salt) may collect in a liquid sump volume after exiting the humidification zone of the humidifier. In some cases, the liquid sump volume comprises or is fluidically connected (e.g., directly fluidically connected) to the liquid outlet of the humidifier. In certain embodiments, the liquid sump volume is in fluid communication with a pump that pumps liquid out of the humidifier. The liquid sump volume may, for example, provide a positive suction pressure on the intake of the pump, and may advantageously prevent negative (e.g., vacuum) suction pressure that could induce deleterious cavitation bubbles. In some cases, the liquid sump volume may advantageously decrease the sensitivity of the humidifier to changes in flow rate, salinity, temperature, and/or heat transfer rate.

In some embodiments, the humidifier is a packed bed humidifier. The packed bed humidifier may comprise a vessel containing a packing material (e.g. polyvinyl chloride (PVC) packing material or other similar materials) disposed in the humidification zone, the packing material being configured to interact with the liquid and/or gas streams. According to some embodiments, the packing can facilitate enhanced direct contact between the liquid stream and the gas stream within the humidifier.

In some embodiments, the humidifier comprises a liquid distributor device configured to produce liquid droplets when the combined liquid stream, feed stream, and/or injected influent stream is transported through the device. For example, a nozzle, a notched trough distributor, or other spraying device may be positioned at the top of the humidifier such that the aqueous feed stream is distributed as droplets (e.g., sprayed) downward to the bottom of the humidifier. The use of a liquid distributor device (e.g., a spraying device) can increase the degree of contact between the combined stream and the gas stream into which condensable fluid from the combined stream is transported. In some such embodiments, the gas stream can be transported in a counter-current direction, relative to the direction along which the aqueous saline stream is transported. For example, the gaseous stream may be transported into the bottom of the humidifier, through the humidifier vessel, and out of the top of the humidifier. In certain embodiments, the remaining portion of condensable fluid that is not transported from the combined stream to the gas stream is collected at or near the bottom of the humidifier in the liquid sump volume and transported out of the humidifier (and out of the humidifier system system) as a concentrate stream (e.g., concentrate saline stream 118 in FIG. 1).

In certain embodiments, the humidifier comprises a plurality of stages (e.g., the humidifier is a multi-stage humidifier). In some embodiments, the plurality of stages comprises a first stage, a last stage, and one or more intermediate stages positioned between the first stage and the last stage. As used herein, the first humidifier stage refers to the first stage of the humidifier encountered by a liquid stream entering the humidifier through the liquid inlet. The first humidifier stage is, therefore, generally the stage of the humidifier positioned in closest proximity to the liquid inlet of the humidifier. In some embodiments, the first humidifier stage comprises or is fluidically connected (e.g., directly fluidically connected) to the liquid inlet of the humidifier (e.g., the liquid inlet of the humidifier is a liquid inlet of the first humidifier stage). As used herein, the last humidifier stage refers to the last stage of the humidifier encountered by a liquid stream flowing through the humidifier. The last humidifier stage is, therefore, generally the stage of the humidifier positioned in closest proximity to the liquid outlet of the humidifier. In some embodiments, the last humidifier stage comprises or is fluidically connected (e.g., directly fluidically connected) to the liquid outlet of the humidifier (e.g., the liquid outlet of the humidifier is a liquid outlet of the last humidifier stage). In the humidifier, the plurality of stages may be vertically arranged (e.g., the first stage may be positioned above the last stage) or horizontally arranged (e.g., the first stage may be positioned to the left or right of the last stage).

The humidifier may have any number of stages. In some embodiments, the humidifier has at least one, at least two, at least three, at least four, at least five, at least six, at least seven, at least eight, at least nine, or at least ten or more stages. In some embodiments, the humidifier has 1-10 stages, 2-10 stages, 3-10 stages, 4-10 stages, 5-10 stages, 6-10 stages, 7-10 stages, 8-10 stages, or 9-10 stages. In some embodiments, the stages are arranged such that they are substantially parallel to each other. In certain cases, the stages are positioned at an angle. In some embodiments, the any number of stages may be contained within a single integral structure. In other embodiments, at least one stage of the any number of stages may be contained within a separate structure.

According to some embodiments, the humidifier is a bubble column humidifier. A bubble column humidifier may be associated with certain advantages over other types of humidifiers, such as increased thermal efficiency. In some embodiments, at least one stage of the bubble column humidifier comprises a bubble generator. In certain embodiments, the bubble generator may act as a gas inlet for the at least one stage. In operation, the at least one stage of the bubble column humidifier may further comprise a liquid layer comprising an amount of a condensable fluid in liquid phase and a dissolved salt (e.g., at least a portion of a combined liquid stream or concentrated remnant thereof).

In some embodiments, the at least one stage may further comprise a vapor distribution region positioned adjacent the liquid layer (e.g., above the liquid layer). The vapor distribution region refers to the space within the stage throughout which vapor is distributed (e.g., the portion of the stage not occupied by the liquid layer). The vapor distribution region may, in certain cases, advantageously damp out flow variations created by random bubbling by allowing a gas to redistribute evenly across the cross section of the humidifier. Additionally, in the free space of the vapor distribution region, large droplets entrained in the gas may have some space to fall back into the liquid layer before the gas enters the subsequent stage. In some embodiments, the vapor distribution region is positioned between two liquid layers of two consecutive stages. The vapor distribution region may serve to separate the two consecutive stages, thereby increasing the thermodynamic effectiveness of the humidifier by keeping the liquid layers of each stage separate. In some embodiments, each stage of a plurality of stages of the bubble column humidifier comprises a bubble generator, a liquid layer, and a vapor distribution region positioned adjacent the liquid layer.

In some embodiments, an influent gas stream (e.g., influent gas stream 120 in FIG. 1) enters the bubble column humidifier through a gas inlet, and an influent liquid stream (e.g., combined liquid stream 114 in FIG. 1) enters the bubble column humidifier through a liquid inlet. The influent gas stream may flow through the bubble generator of the at least one stage of the humidifier, thereby forming a plurality of gas bubbles. In some cases, the gas bubbles flow through the liquid layer of the at least one stage of the humidifier. As the gas bubbles directly contact the liquid layer, which may have a higher temperature than the gas bubbles, heat and/or mass (e.g., the condensable fluid) may be transferred from the liquid layer to the gas bubbles through an evaporation (e.g., humidification) process, thereby forming a heated, at least partially humidified gas stream and a cooled effluent liquid stream (e.g., concentrate stream 118 in FIG. 1) having a higher concentration of the dissolved salt than the influent liquid stream. In certain embodiments, the condensable fluid is water, and the humidified gas stream is enriched in water vapor relative to the influent gas stream received from the main humidifier gas inlet. In some embodiments, bubbles of the heated, at least partially humidified gas exit the liquid layer and recombine in the vapor distribution region, and the heated, at least partially humidified gas is substantially evenly distributed throughout the vapor distribution region. The humidified gas stream may exit the bubble column humidifier through the main humidifier gas outlet, and the concentrate stream may exit the bubble column humidifier through the main humidifier liquid outlet.

In some embodiments, the bubble column humidifier comprises a plurality of stages, and one or more stages of the plurality of stages comprise a liquid layer comprising an amount of a condensable fluid in liquid phase and a dissolved salt (e.g., at least a portion of the combined liquid stream or concentrated remnant thereof). In some embodiments relating to multi-stage bubble column humidifiers, the temperature of a liquid layer of a first stage (e.g., the topmost stage in a vertically arranged humidifier) may be higher than the temperature of a liquid layer of a second stage (e.g., a stage positioned below the first stage in a vertically arranged humidifier), which may be higher than the temperature of a liquid layer of a third stage (e.g., a stage positioned below the second stage in a vertically arranged humidifier). In some embodiments, each stage in a multi-stage bubble column humidifier operates at a temperature below that of the previous stage (e.g., the stage above it, in embodiments comprising vertically arranged humidifiers).

The presence of multiple stages within the bubble column humidifier may, in some cases, advantageously result in increased humidification of a gas stream. For example, the presence of multiple stages may provide numerous locations where the gas may be humidified. That is, the gas may travel through more than one liquid layer in which at least a portion of the gas undergoes evaporation (e.g., humidification). In addition, the presence of multiple stages within the bubble column humidifier may advantageously enable greater flexibility for fluid flow (e.g., extraction and/or injection of liquid streams and/or gas streams from intermediate humidifier stages).

In some embodiments, an influent liquid stream (e.g. combined liquid stream 214) enters the first stage of the bubble column humidifier through a liquid inlet, and forms a first-stage liquid layer. Direct contact with partially humidified gas bubbles traveling through the first-stage liquid layer of may cool and concentrate the liquid therein. In some embodiments, the cooled and concentrated remnants of the first-stage liquid layer may flow to the second stage of the bubble column humidifier to form a second-stage liquid layer. Direct contact with partially humidified gas bubbles traveling through the second-stage liquid layer may further cool and concentrate the liquid therein. In some embodiments, the further cooled and concentrated remnants of the second-stage liquid layer may flow to an additional stage to form a liquid layer therein. In other embodiments, the further cooled and concentrated remnants may be discharged from the bubble column humidifier as a concentrate stream (e.g. concentrate stream 118).

In some embodiments, the humidifier (e.g., the bubble column humidifier) is configured to have a relatively high evaporation rate. In certain cases, for example, the humidifier has an evaporation rate of at least about 80 m3/day [about 503.1 barrels/day], at least about 90 m3/day [566.0 barrels/day], at least about 100 m3/day [628.9 barrels/day], at least about 125 m3/day [786.2 barrels/day], at least about 150 m3/day [943.4 barrels/day], at least about 175 m3/day [1,101 barrels a day], at least about 200 m3/day [1258 barrels/day], at least about 225 m3/day [1,415 barrels/day], at least about 250 m3/day [1,572 barrels/day], at least about 275 m3/day [1,730 barrels/day], at least about 300 m3/day [1,887 barrels/day], at least about 400 m3/day [2,516 barrels/day], at least about 500 m3/day [3,145 barrels/day], at least about 600 m3/day [3,774 barrels/day], at least about 700 m3/day [4,403 barrels/day], or at least about 800 m3/day [5,031 barrels/day]. In some embodiments, the humidifier has an evaporation rate of about 80 m3/day [503.1 barrels/day] to about 800 m3/day [5,031 barrels/day], about 90 m3/day [566.0 barrels/day] to about 800 m3/day [5,031 barrels/day], about 100 m3/day [628.9 barrels/day] to about 800 m3/day [5,031 barrels/day], about 125 m3/day [786.2 barrels/day] to about 800 m3/day [5,031 barrels/day], about 150 m3/day [943.4 barrels/day] to about 800 m3/day [5,031 barrels/day], about 175 m3/day [1,101 barrels a day] to about 800 m3/day [5,031 barrels/day], about 200 m3/day [1258 barrels/day] to about 800 m3/day [5,031 barrels/day], about 225 m3/day [1,415 barrels/day] to about 800 m3/day [5,031 barrels/day], about 250 m3/day [1,572 barrels/day] to about 800 m3/day [5,031 barrels/day], about 275 m3/day [1,730 barrels/day] to about 800 m3/day [5,031 barrels/day], about 300 m3/day [1,887 barrels/day] to about 800 m3/day [5,031 barrels/day], about 400 m3/day [2,516 barrels/day] to about 800 m3/day [5,031 barrels/day], about 500 m3/day [3,145 barrels/day] to about 800 m3/day [5,031 barrels/day], about 600 m3/day [3,774 barrels/day] to about 800 m3/day [5,031 barrels/day], or about 700 m3/day [4,403 barrels/day] to about 800 m3/day [5,031 barrels/day]. As used herein a barrel refers to a US oil barrel, a unit of volume equal to 42 US gallons. The evaporation rate of the humidifier may be obtained by measuring the total liquid output volume of the humidifier (e.g., the volume of the concentrate stream) over a time period (e.g., one day) and subtracting the input volume of the humidifier (e.g., the combined liquid stream) over the same time period.

In some embodiments, the temperature of the concentrate stream is relatively low, as compared to the temperature of the combine liquid stream. In certain embodiments, the temperature of the concentrate stream is less than about 70° C. [158° F.], less than about 60° C. [140° F.], less than about 50° C. [122° F.], less than about 40° C. [104° F.], less than about 30° C. [86° F.], less than about 20° C. [68° F.], less than about 10° C. [50° F.], or less than about 5° C. [41° F.]. In some embodiments, the temperature of the concentrate stream is in the range of about 70° C. [158° F.] to about 50° C. [122° F.], about 60° C. [140° F.] to about 40° C. [104° F.], about 50° C. [122° F.] to about 30° C. [86° F.], about 40° C. [104° F.] to about 20° C. [68° F.], about 30° C. [86° F.] to about 10° C. [50° F.], or about 20° C. [68° F.] to about 5° C. [41° F.].

According to some embodiments, the concentrate stream has a relatively high salinity. In certain embodiments, the salinity in the concentrate stream is at least about 0.1%, at least about 0.5%, at least about 1%, at least about 5%, at least about 10%, at least about 15%, at least about 20%, at least about 25%, or at least about 30%, (and/or, in certain embodiments, up to the solubility limit of at least one dissolved salt in the concentrate stream). In some embodiments, the concentration of the dissolved salt in the concentrate stream is in the range of about 0.1% to about 1%, about 0.1% to about 5%, about 0.1% to about 10%, about 0.1% to about 15%, about 0.1% to about 20%, about 0.1% to about 25%, about 0.1% to about 30%, about 1% to about 5%, about 1% to about 10%, about 1% to about 15%, about 1% to about 20%, about 1% to about 25%, about 1% to about 30%, about 5% to about 10%, about 5% to about 15%, about 5% to about 20%, about 5% to about 25%, about 5% to about 30%, about 10% to about 15%, about 10% to about 20%, about 10% to about 25%, or about 10% to about 30%.

In some embodiments, the concentration of the dissolved salt in the concentrate stream is substantially greater than the concentration of the dissolved salt in the combined liquid stream. In some cases, the concentration of the dissolved salt in the concentrate stream is at least about 0.5%, about 1%, about 2%, about 5%, about 10%, about 15%, or about 20% greater than the concentration of the dissolved salt in the combined liquid stream.

According to certain embodiments, the humidifier feed stream flow path may comprise an optional second heating device in addition to the first heating device. In these embodiments, second heating device may be located upstream of a first heating device along the humidifier feed stream flow path. In such embodiments, the second heating device is configured to heat a feed stream to a second temperature and the first heating device is configured to heat the feed stream to a first temperature. For example, in FIG. 1, feed stream 116 may be heated to a second temperature in the second heating device (not shown), prior to entering first heating device 103 and being heated to a first temperature, producing heated stream 112. Heated stream 112 may be combined with injected influent stream 110 at injection junction 107 and fed to humidifier 102. In some such embodiments, the temperature of the influent stream injected into the influent injection junction is closer to the first temperature than the second temperature. In certain embodiments, the temperature of the injected influent stream is closer to the first temperature than the temperature of the feed stream entering the second heating device.

The second heating device may be any device that is capable of transferring heat to a fluid stream. In some embodiments, the second heating device comprises a first fluidic pathway. In certain cases, the second heating device comprises a first fluidic pathway inlet and a first fluidic pathway outlet. The first fluidic pathway inlet of the second heating device may be a liquid inlet of the first fluidic pathway, and the first fluidic pathway outlet of the second heating device may be a liquid outlet of the first fluidic pathway. In some embodiments, the first fluidic pathway inlet of the second heating device is fluidically connected to a source of a feed stream comprising a condensable fluid in liquid phase and a dissolved salt. In certain embodiments, the first fluidic pathway outlet of the second heating device comprises or is fluidically connected to a liquid inlet of the first heating device.

In some embodiments, the second heating device is a heat exchanger. The second heating device may be any type of heat exchanger known in the art. In some cases, the heat exchanger comprises a first fluidic pathway and a second fluidic pathway. A first fluid stream (e.g. a feed stream) may flow through the first fluidic pathway, and a second fluid stream (e.g. a condensate-containing stream) may flow through the second fluidic pathway. The first fluid stream and the second fluid stream may be in direct or indirect contact, and heat may be transferred between the first fluid stream and the second fluid stream. In some embodiments, the first fluid stream and the second fluid stream are only in indirect contact. In certain embodiments, the second fluid stream comprises a heating fluid. The heating fluid may be any fluid capable of absorbing and transferring heat. Non-limiting examples of suitable heating fluids include water, air, saturated/superheated steam, synthetic organic-based non-aqueous fluids, glycol, brines, and/or mineral oils.

In some embodiments, a first fluid stream flows through the first fluidic pathway in a first direction, and a second fluid stream flows through the second fluidic pathway in a second direction that is substantially opposite from the first direction (e.g., counter flow), substantially the same as the first direction (e.g., parallel flow), or substantially perpendicular to the first direction (e.g., cross flow). In certain cases, a counter-flow heat exchanger may be more efficient than other types of heat exchangers. In some embodiments, the second heating device is a counter-flow heat exchanger. In some embodiments, more than two fluid streams may flow through the heat exchanger.

In some embodiments, the first fluid stream flowing through the first fluidic pathway of the second heating device and/or the second fluid stream flowing through the second fluidic pathway of the second heating device are liquid streams, and the second heating device is a liquid-to-liquid heat exchanger. In other embodiments, the first fluid stream flowing through the first fluidic pathway of the second heating device and/or the second fluid stream flowing through the second fluidic pathway of the second heating device are gas streams. In some embodiments, the first fluid stream and/or second fluid stream do not undergo a phase change (e.g., liquid to gas or vice versa) within the second heating device.

Examples of suitable heat exchangers include, but are not limited to, plate-and-frame heat exchangers, shell-and-tube heat exchangers, tube-and-tube heat exchangers, plate heat exchangers, plate-and-shell heat exchangers, and the like. In a particular, non-limiting embodiment, the second heating device is a plate-and-frame heat exchanger.

In some embodiments, the second heating device may exhibit relatively high heat transfer rates. In some embodiments, the second heating device may have a heat transfer coefficient of at least about 150 W/(m2 K), at least about 200 W/(m2 K), at least about 500 W/(m2 K), at least about 1000 W/(m2 K), at least about 2000 W/(m2 K), at least about 3000 W/(m2 K), at least about 4000 W/(m2 K), at least about 5000 W/(m2 K), at least about 6000 W/(m2 K), at least about 7000 W/(m2 K), at least about 8000 W/(m2 K), at least about 9000 W/(m2 K), or at least about 10,000 W/(m2 K). In some embodiments, the second heating device may have a heat transfer coefficient in the range of about 150 W/(m2 K) to about 10,000 W/(m2 K), about 200 W/(m2 K) to about 10,000 W/(m2 K), about 500 W/(m2 K) to about 10,000 W/(m2 K), about 1000 W/(m2 K) to about 10,000 W/(m2 K), about 2000 W/(m2 K) to about 10,000 W/(m2 K), about 3000 W/(m2 K) to about 10,000 W/(m2 K), about 4000 W/(m2 K) to about 10,000 W/(m2 K), about 5000 W/(m2 K) to about 10,000 W/(m2 K), about 6000 W/(m2 K) to about 10,000 W/(m2 K), about 7000 W/(m2 K) to about 10,000 W/(m2 K), about 8000 W/(m2 K) to about 10,000 W/(m2 K), or about 9000 W/(m2 K) to about 10,000 W/(m2 K).

In some embodiments, the second heating device is a heat exchanger is configured transfer heat from a fluid stream carrying heat from another heat source. In some cases, the heat source is another system comprising a humidifier, such as a humidifier-dehumidifier system. As will be explained in more detail later, a dehumidifier in the humidifier-dehumidifier system may be configured to transfer heat recovered from a humidification-dehumidification process to a fluid stream, and the second heating device may be configured to receive the fluid stream and transfer heat from it. In certain cases, a humidifier-dehumidifier system comprises a humidifier system that includes the second heating device, and a dehumidifier that is the heat source for the second heating device.

The second heating device may, in some cases, increase the temperature of one or more fluid streams flowing through (or otherwise in contact with) it. For example, the difference between the temperature of a fluid stream exiting the second heating device and the fluid stream entering the second heating device may be at least about 5° C. [9° F.], at least about 10° C. [9° F.], at least about 15° C. [27° F.], at least about 20° C. [36° F.], at least about 30° C. [54° F.], at least about 40° C. [72° F.], or at least about 50° C. [90° F.]. In some embodiments, the difference between the temperature of a fluid stream exiting the second heating device and the fluid stream entering the second heating device may be in the range of about 5° C. [9° F.] to about 10° C. [18° F.], about 5° C. [9° F.] to about 15° C. [27° F.], about 5° C. [9° F.] to about 20° C. [36° F.], about 5° C. [9° F.] to about 30° C. [54° F.], about 5° C. [9° F.] to about 40° C. [72° F.], about 5° C. [9° F.] to about 50° C. [90° F.], about 10° C. [18° F.] to about 20° C. [36° F.], about 10° C. [18° F.] to about 30° C. [54° F.], about 10° C. [18° F.] to about 40° C. [72° F.], about 10° C. [18° F.] to about 50° C. [90° F.], about 20° C. [36° F.] to about 30° C. [54° F.], about 20° C. [36° F.] to about 40° C. [72° F.], or about 20° C. [36° F.] to about 50° C. [90° F.]. In some cases, the temperature of a fluid stream (e.g., the feed stream) being heated in the second heating device remains below the boiling point of the fluid stream.

The second heating device may, in certain embodiments, heat one or more fluid streams flowing through it (or otherwise in contact with it) to a temperature that is relatively close to the dew point of humid air that is in vapor-liquid equilibrium with 95° C. [203° F.] saline water with a saturated concentration of sodium chloride. For example, the second heating device may heat a fluid stream to least about 50° C. [132° F.], at least about 60° C. [140° F.], at least about 70° C. [158° F.], or at least about 80° C. [176° F.]. In some embodiments, the second heating device may heat a fluid stream to a temperature in the range of about 50° C. [140° F.] to about 60° C. [140° F.], about 60° C. [140° F.] to about 70° C. [158° F.], or about 70° C. [158° F.] to about 80° C. [176° F.].

The humidifier feed stream flow path may comprise an optional combined stream heating device in addition to the first heating device, according to some embodiments. The combined stream heating device may be located downstream of an injection junction located on the humidifier feed stream flow path. In some such embodiments, the combined stream heating device is configured receive the combined liquid stream from the injection junction and heat the combined liquid stream to a third temperature, and the first heating device is configured to heat the feed stream to a first temperature. For example, in FIG. 1, feed stream 116 may be heated to a first temperature in first heating device 103 to produce heated stream 112. Heated stream 112 may be combined with injected influent stream 110 at injection junction 107, producing combined liquid stream 114. The combined liquid stream 114 may then enter the combined stream heating device (not shown) and be heated to a third temperature, prior to entering humidifier 102. In some such embodiments, the temperature of the influent stream injected into the influent injection junction is closer to the first temperature than the third temperature. In certain embodiments, the temperature of the injected influent stream is closer to the first temperature than the temperature of the feed stream entering the first heating device.

In certain embodiments, the temperature of the injected influent stream is substantially lower than the temperature of the stream exiting the combined stream heating device. For example, the temperature of the injected influent stream may be lower than the temperature of combined stream exiting the combined stream heating device by more than about 5° C. [9° F.], by more than about 10° C. [18° F.], by more than about 15° C. [27° F.], by more than about 20° C. [36° F.], by more than about 30° C. [54° F.], by more than about 40° C. [72° F.], or by more than about 50° C. [90° F.]. In some embodiments, the temperature of the injected influent stream may be lower than the temperature of combined stream exiting the combined stream heating device by about 10° C. [18° F.] to about 15° C. [27° F.], about 15° C. [27° F.] to about 30° C. [54° F.], about 30° C. [54° F.] to about 50° C. [90° F.], about 50° C. [90° F.] to about 75° C. [135° F.], about 75° C. [135° F.] to about 100° C. [180° F.].

In some embodiments, the temperature of the injected influent stream is substantially closer to the temperature of the feed stream entering the injection junction into which the influent stream is injected the than the temperature of combined stream exiting the combined stream heating device. For example, the difference in magnitude between the temperature of the injected influent stream and the temperature of the feed stream entering the injection junction into which the influent stream is injected may be smaller than the difference in magnitude between the temperature of the injected influent stream and the temperature of combined stream exiting the combined stream heating device by at least about 50° C. [90° F.], at least about 40° C. [72° F.], at least about 30° C. [54° F.], at least about 20° C. [36° F.], at least about 15° C. [27° F.], at least about 10° C. [18° F.], and/or at least about 5° C. [9° F.]. In some cases the difference in magnitude between the temperature of the injected influent and the temperature of the feed stream entering the injection junction into which the influent stream is injected may be smaller than the difference in magnitude between the temperature of the injected influent stream and the temperature of the feed stream entering the first heating device by about 50° C. [90° F.] to about 30° C. [54° F.], by about 40° C. [72° F.] to about 20° C. [36° F.], by about 30° C. [54° F.] to about 10° C. [18° F.], or about to 15° C. [27° F.] to about 5° C. [9° F.].

The combined stream heating device may be any device that is capable of transferring heat to a fluid stream. In some embodiments, the combined stream heating device comprises a first fluidic pathway. In certain cases, the combined stream heating device comprises a first fluidic pathway inlet and a first fluidic pathway outlet. The first fluidic pathway inlet of the heating device may be a liquid inlet of the first fluidic pathway, and the first fluidic pathway outlet of the combined stream heating device may be a liquid outlet of the first fluidic pathway. In some embodiments, the first fluidic pathway inlet of the combined stream heating device is fluidically connected an outlet of the first heating device and/or an influent injection junction. In certain embodiments, the first fluidic pathway outlet of the combined stream heating device comprises or is fluidically connected to a liquid inlet of the humidifier.

In some embodiments, the combined stream heating device is a heat exchanger. The combined stream heating device may be any type of heat exchanger known in the art. In some cases, the heat exchanger comprises a first fluidic pathway and a second fluidic pathway. A first fluid stream (e.g. combined liquid stream 114 in FIG. 1) may flow through the first fluidic pathway, and a second fluid stream (e.g. a heating fluid stream) may flow through the second fluidic pathway. The first fluid stream and the second fluid stream may be in direct or indirect contact, and heat may be transferred between the first fluid stream and the second fluid stream. In some embodiments, the first fluid stream and the second fluid stream are only in indirect contact. In certain embodiments, the second fluid stream comprises a heating fluid. The heating fluid may be any fluid capable of absorbing and transferring heat. Non-limiting examples of suitable heating fluids include water, air, saturated/superheated steam, synthetic organic-based non-aqueous fluids, glycol, brines, and/or mineral oils.

In some embodiments, a first fluid stream flows through the first fluidic pathway in a first direction, and a second fluid stream flows through the second fluidic pathway in a second direction that is substantially opposite from the first direction (e.g., counter flow), substantially the same as the first direction (e.g., parallel flow), or substantially perpendicular to the first direction (e.g., cross flow). In certain cases, a counter-flow heat exchanger may be more efficient than other types of heat exchangers. In some embodiments, the combined stream heating device is a counter-flow heat exchanger. In some embodiments, more than two fluid streams may flow through the heat exchanger.

In some embodiments, the first fluid stream flowing through the first fluidic pathway of the combined stream heating device and/or the second fluid stream flowing through the second fluidic pathway of the combined stream heating device are liquid streams, and the combined stream heating device is a liquid-to-liquid heat exchanger. In other embodiments, the first fluid stream flowing through the first fluidic pathway of the combined stream heating device and/or the second fluid stream flowing through the second fluidic pathway of the combined stream heating device are gas streams. In some embodiments, the first fluid stream and/or second fluid stream do not undergo a phase change (e.g., liquid to gas or vice versa) within the combined stream heating device.

Examples of suitable heat exchangers include, but are not limited to, plate-and-frame heat exchangers, shell-and-tube heat exchangers, tube-and-tube heat exchangers, plate heat exchangers, plate-and-shell heat exchangers, and the like. In a particular, non-limiting embodiment, the combined stream heating device is a plate-and-frame heat exchanger.

In some embodiments, the combined stream heating device may exhibit relatively high heat transfer rates. In some embodiments, the combined stream heating device may have a heat transfer coefficient of at least about 150 W/(m2 K), at least about 200 W/(m2 K), at least about 500 W/(m2 K), at least about 1000 W/(m2 K), at least about 2000 W/(m2 K), at least about 3000 W/(m2 K), at least about 4000 W/(m2 K), at least about 5000 W/(m2 K), at least about 6000 W/(m2 K), at least about 7000 W/(m2 K), at least about 8000 W/(m2 K), at least about 9000 W/(m2 K), or at least about 10,000 W/(m2 K). In some embodiments, the combined stream heating device may have a heat transfer coefficient in the range of about 150 W/(m2 K) to about 10,000 W/(m2 K), about 200 W/(m2 K) to about 10,000 W/(m2 K), about 500 W/(m2 K) to about 10,000 W/(m2 K), about 1000 W/(m2 K) to about 10,000 W/(m2 K), about 2000 W/(m2 K) to about 10,000 W/(m2 K), about 3000 W/(m2 K) to about 10,000 W/(m2 K), about 4000 W/(m2 K) to about 10,000 W/(m2 K), about 5000 W/(m2 K) to about 10,000 W/(m2 K), about 6000 W/(m2 K) to about 10,000 W/(m2 K), about 7000 W/(m2 K) to about 10,000 W/(m2 K), about 8000 W/(m2 K) to about 10,000 W/(m2 K), or about 9000 W/(m2 K) to about 10,000 W/(m2 K).

In some embodiments, the combined stream heating device is a heat exchanger is configured transfer heat from a fluid stream, the heat being generated from a heat source. In certain cases, the heat source is a boiler. For example, the boiler may be configured to heat a fluid stream (e.g. a heating fluid stream), and the combined stream heating device may be configured to receive the fluid stream and transfer heat from it. In other cases, the heat source is another system, such as a cooling jacket for a diesel generator. For example, the cooling jacket may be configured to transfer heat produced by the diesel generator to the fluid stream, and the combined stream heating device may be configured to receive the fluid stream and transfer heat from it.

In some embodiments, the combined stream heating device is a heat collection device. The heat collection device may be configured to produce and/or store and/or utilize thermal energy (e.g., in the form of combustion of natural gas, solar energy, waste heat from a power plant, or waste heat from combusted exhaust). In certain cases, the combined stream heating device is configured to convert electrical energy to thermal energy. For example, the combined stream heating device may be an electric heater. In some embodiments, the combined stream heating device comprises a furnace (e.g., a combustion furnace).

The combined stream heating device may, in some cases, increase the temperature of one or more fluid streams flowing through it (or otherwise in contact with it). For example, the difference between the temperature of a fluid stream entering the combined stream heating device and the fluid stream exiting the combined stream heating device may be at least about 5° C. [9° F.], at least about 10° C. [18° F.], at least about 15° C. [27° F.], at least about 20° C. [36° F.], at least about 30° C. [54° F.], at least about 40° C. [72° F.], or at least about 50° C. [90° F.]. In some embodiments, the difference between the temperature of a fluid stream entering the combined stream heating device and the fluid stream first exiting the combined stream heating device may be in the range of about 5° C. [9° F.] to about 10° C. [18° F.], about 5° C. [9° F.] to about 15° C. [27° F.], about 5° C. [9° F.] to about 20° C. [36° F.], about 5° C. [9° F.] to about 30° C. [54° F.], about 5° C. [9° F.] to about 40° C. [72° F.], about 5° C. [9° F.] to about 50° C. [90° F.], about 10° C. [18° F.] to about 20° C. [36° F.], about 10° C. [18° F.] to about 30° C. [54° F.], about 10° C. [18° F.] to about 40° C. [72° F.], about 10° C. [18° F.] to about 50° C. [90° F.], about 20° C. [36° F.] to about 30° C. [54° F.], about 20° C. [36° F.] to about 40° C. [72° F.], or about 20° C. [36° F.] to about 50° C. [90° F.]. In some cases, the temperature of a fluid stream (e.g., a first fluid stream) being heated in the combined stream heating device remains below the boiling point of the fluid stream.

The combined stream heating device may, in certain embodiments, heat one or more liquid streams flowing through it (or otherwise in contact with it) to a temperature that is relatively to the boiling point of the liquid stream. For example, the combined stream heating device may heat a liquid stream to least about 80° C. [176° F.], at least about 90° C. [194° F.], at least about 100° C. [210° F.], or, in some cases, at least about the boiling point of the liquid stream. In some embodiments, the combined stream heating device may heat a liquid stream to a temperature in the range of about 80° C. [176° F.] to about 90° C. [194° F.], about 90° C. [194° F.] to about 100° C. [210° F.], or, in certain embodiments, about 100° C. [210° F.] to about the boiling point of the liquid stream.

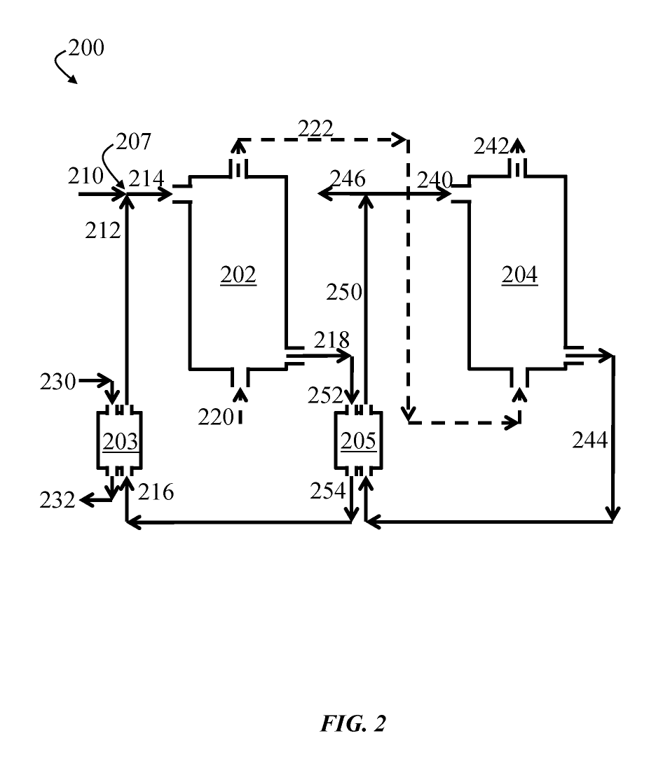

In some embodiments, the system further comprises a dehumidifier fluidically connected to the humidifier. FIG. 2 illustrates an exemplary system comprising a dehumidifier. As shown in FIG. 2, humidifier-dehumidifier system 200 comprises humidifier 202, first heating device 203, injection junction 207, second heating device 205, and dehumidifier 204. Humidifier 203 comprises a liquid inlet, shown in FIG. 2 as the inlet receiving stream 214, which is fluidically connected to and/or comprises injection junction 207. Humidifier 203 additionally comprises the following ports: a gas inlet, shown in the figure as inlet receiving stream 220; a liquid outlet, shown as transmitting stream 218, and a gas outlet, shown as transmitting stream 222. First heating device 202 is fluidically connected to injection junction 207 via a first fluidic pathway outlet, shown in FIG. 2 as transmitting stream 212. The first fluidic pathway outlet is fluidically connected to a first fluidic pathway inlet, which is shown as receiving stream 216. First heating device 203 may also comprise an optional second fluidic pathway inlet fluidically connected to an optional second fluidic pathway outlet, shown as transmitting streams 230 and 232, respectively. Second heating device 205 is fluidically connected to first heating device 203 via a first fluidic pathway outlet, shown in FIG. 2 as transmitting stream 254. The first fluidic pathway outlet of the second heating device is fluidically connected to a first fluidic pathway inlet, shown in FIG. 2 as receiving stream 252. Second heating device 205 also comprises a second fluidic pathway inlet fluidically connected to a second fluidic pathway outlet, shown as transmitting streams 250 and 252, respectively. The first fluidic pathway inlet of second heating device 205 is fluidically connected to the liquid outlet of humidifier 202. Dehumidifier 204 is fluidically connected to the gas outlet of humidifier 202 via a gas inlet shown as receiving stream 222. Dehumidifier 204 additionally comprises the following ports: a liquid inlet, shown in FIG. 2 as receiving stream 240; a liquid outlet, shown as transmitting stream 244, and a gas outlet, shown as transmitting stream 242. The liquid outlet of dehumidifier 204 is fluidically connected to the second fluidic pathway inlet of second heating device 205. The liquid inlet of dehumidifier 204 is fluidically connected to the second fluidic pathway outlet of second heating device 205.

In operation, humidifier 202, first heating device 203, and influent injection junction 207 may be operated similarly to humidifier 102, first heating device 103, and influent injection junction 107, which were described in relation to FIG. 1. In addition, humidified gas stream 222, comprising a non-condensable gas and a condensable fluid in vapor form, may be directed to flow from the gas outlet of humidifier 202 to the gas inlet of the dehumidifier 204. In some embodiments, humidified gas stream 222 may contact cooling liquid stream 240, comprising the condensable fluid in liquid form, within dehumidifier 240. Cooling liquid stream 240 may have a temperature lower than that of humidified gas stream 222. The contact of the two streams can result in a transfer of heat from the gas to the liquid. Humidified gas stream 222 can be cooled below its dew point to cause the condensation of excess humidity. In some such embodiments, this transfer can produce a hot condensate-containing stream 244 from cooling liquid stream 240, the condensate-containing stream having a greater temperature and quantity of condonable fluid liquid than cooling liquid stream 240. The cooled dehumidified gas may exit the dehumidifier at a reduced temperature and quantity of condensable fluid as dehumidified gas stream 242.

Second heating device 205 may receive hot condensate-containing stream 244 and a feed stream 252 comprising a condensable fluid in liquid phase and a dissolved salt. In some embodiments, second heating device 205 is configured to receive condensate-containing stream 244 through its second fluidic pathway inlet and feed stream 252 through its first fluidic pathway inlet. Within second heating device 205, heat may be transferred from condensate-containing stream 244 to feed stream 252 to produce preheated stream 254 from feed stream 252 and cooled liquid stream 250 such that preheated stream 254 has a greater temperature than feed stream 252 and cooled liquid stream 250 has a lower temperature than condensate-containing stream 244. In some embodiments, at least a portion of cooled liquid stream 250 is reintroduced into the dehumidifier.

After exiting second heating device 205, at least a portion of condensable fluid may be removed from cooled liquid stream 250 as recovered condensate stream 246, and the remnants of the stream may be reintroduced into the dehumidifier as cooling liquid stream 240. In certain embodiments, the at least a portion of condensable fluid may be removed continuously. In other embodiments, the removal may be intermittent. In an alternative embodiment, the recovered condensate stream may be removed upstream of the second heating device, for example, from the condensate-containing stream. In such embodiments, the recovered condensate stream may be removed from a location exterior to the dehumidifier, for example, from a conduit conveying the condensate-containing stream to the second heating device, or from a location interior to the dehumidifier, for example, from a volume of condensate-containing stream contained within a sump of the dehumidifier. In some embodiments, recovered condensate stream 246 is discharged from humidifier-dehumidifier system 200 after being removed from the cooled liquid stream and/or condensate-containing stream.

In certain embodiments, at least a portion of the concentrate stream 218 may be recirculated such that feed stream 252 comprises the at least a portion of concentrate stream 218. In the embodiment shown in FIG. 2, the entirety of concentrate stream 218 is recirculated. In other embodiments, at least a portion of concentrate stream 218 is discharged from humidifier-dehumidifier system 200. In some embodiments, at least a portion of concentrate stream 218 can be recirculated and another portion can be discharged from humidifier-dehumidifier system 200 to maintain a steady-state salinity in an active system volume comprising the dissolved-salt-containing liquid contained in the humidifier and humidifier flow path. In certain cases, the discharge and/or recirculation of stream 218 is controlled such that a steady-state volume of liquid is maintained in the active system volume. In other cases, the active system volume and its salinity is controlled to fluctuate.

The dehumidifier may be any type of dehumidifier known in the art. In some embodiments, the dehumidifier is configured to receive a humidified gas stream (e.g., humidified gas stream 222 in FIG. 2) as an inlet stream. The dehumidifier may also be configured to receive a cooling liquid stream (e.g., cooling liquid stream 240 as shown in FIG. 2) as an inlet stream. In some embodiments, the cooling liquid stream comprises water. In certain cases, the cooling liquid stream comprises substantially pure water (e.g., water having a relatively low dissolved salt concentration).

In the dehumidifier, the humidified gas stream may come into contact (e.g., direct or indirect contact) with the cooling liquid stream. The humidified gas stream may have a higher temperature than the cooling liquid stream, and upon contact of the humidified gas stream and the cooling liquid stream, heat and/or mass may be transferred from the humidified gas stream to the cooling liquid stream. In certain embodiments, the humidified gas stream comprises the condensable fluid in vapor phase and a non-condensable gas, and at least a portion of the condensable fluid is transferred from the humidified gas stream to the cooling liquid stream via a condensation (e.g., dehumidification) process, thereby producing a condensate-containing stream comprising the condensable fluid in liquid phase and an at least partially dehumidified gas stream. In certain cases, the condensable fluid is water, and the dehumidified gas stream is lean in water vapor relative to the humidified gas stream. In some embodiments, the condensate-containing stream comprises substantially pure water. In certain cases, the condensate-containing stream comprises water in the amount of at least about 95 wt. %, at least about 99 wt. %, at least about 99.9 wt. %, or at least about 99.99 wt. % (and/or, in certain embodiments, up to about 99.999 wt. %, or more).

In some embodiments, the dehumidifier is configured such that a liquid inlet is positioned at a first end (e.g., a top end) of the dehumidifier, and a main gas inlet is positioned at a second, opposite end (e.g., a bottom end) of the dehumidifier. The dehumidifier may also comprise a liquid outlet at the second end of the dehumidifier and a gas outlet at the first end of the dehumidifier. Such a configuration may facilitate the flow of a liquid stream (e.g., the cooling liquid stream) in a first direction through the dehumidifier from the liquid inlet to the liquid outlet and the flow of a gas stream (e.g., the humidified gas stream) in a second, substantially opposite direction through the dehumidifier from the main gas inlet to the gas outlet, which may advantageously result in high thermal efficiency. In certain embodiments, the dehumidifier may further comprise at least one intermediate extraction inlet.

In certain embodiments, the dehumidifier comprises a plurality of stages (e.g., the dehumidifier is a multi-stage dehumidifier). In some embodiments, the plurality of stages comprises a first stage, a last stage, and one or more intermediate stages positioned between the first stage and the last stage. As used herein, the first dehumidifier stage refers to the first stage of the dehumidifier encountered by a liquid stream entering the dehumidifier through the liquid inlet. The first dehumidifier stage is, therefore, generally the stage of the dehumidifier positioned in closest proximity to the dehumidifier liquid inlet. In some embodiments, the first dehumidifier stage is fluidically connected (e.g., directly fluidically connected) to the dehumidifier liquid inlet (e.g., the dehumidifier liquid inlet is a liquid inlet of the first dehumidifier stage). As used herein, the last dehumidifier stage refers to the last stage of the dehumidifier encountered by a liquid stream flowing through the dehumidifier. The last dehumidifier stage is, therefore, generally the stage of the dehumidifier positioned in closest proximity to the dehumidifier liquid outlet. In some embodiments, the last dehumidifier stage is fluidically connected (e.g., directly fluidically connected) to the dehumidifier liquid outlet (e.g., the dehumidifier liquid outlet is a liquid outlet of the last dehumidifier stage). In the dehumidifier, the plurality of stages may be vertically arranged (e.g., the first stage may be positioned above the last stage) or horizontally arranged (e.g., the first stage may be positioned to the left or right of the last stage).

The dehumidifier may have any number of stages. In some embodiments, the dehumidifier has at least one, at least two, at least three, at least four, at least five, at least six, at least seven, at least eight, at least nine, or at least ten or more stages. In some embodiments, the dehumidifier has 1-10 stages, 2-10 stages, 3-10 stages, 4-10 stages, 5-10 stages, 6-10 stages, 7-10 stages, 8-10 stages, or 9-10 stages. In some embodiments, the stages are arranged such that they are substantially parallel to each other. In certain cases, the stages are positioned at an angle. In some embodiments, the any number of stages may be contained within a single integral structure. In other embodiments, at least one stage of the any number of stages may be contained within a separate structure.

In some embodiments, the dehumidifier further comprises a gas distribution chamber positioned between the main dehumidifier gas inlet and the plurality of stages. In certain embodiments, such as those embodiments in which the dehumidifier comprises a plurality of vertically-arranged stages, the gas distribution chamber is positioned at or near the bottom portion of the dehumidifier. In some embodiments, the gas distribution chamber is fluidically connected (e.g., directly fluidically connected) to the main dehumidifier gas inlet. The gas distribution chamber may have sufficient volume to allow a gas stream (e.g., the humidified gas stream) to substantially evenly diffuse over the cross section of the dehumidifier.

In some cases, the gas distribution chamber further comprises a liquid layer (e.g., a liquid sump volume). For example, liquid (e.g., comprising the condensable fluid in liquid phase) may collect in the liquid sump volume after exiting the last stage of the dehumidifier. In some cases, the liquid sump volume is fluidically connected (e.g., directly fluidically connected) to the liquid outlet of the dehumidifier. In certain embodiments, the liquid sump volume is in fluid communication with a pump that pumps liquid out of the dehumidifier. The liquid sump volume may, for example, provide a positive suction pressure on the intake of the pump, and may advantageously prevent negative (e.g., vacuum) suction pressure that could induce deleterious cavitation bubbles. In some cases, the liquid sump volume may advantageously decrease the sensitivity of the dehumidifier to changes in flow rate, salinity, temperature, and/or heat transfer rate.

In some embodiments, the dehumidifier is a bubble column condenser. As noted above, a bubble column condenser may be associated with certain advantages over other types of dehumidifiers, such as increased thermal efficiency. In some embodiments, at least one stage of the bubble column condenser comprises a bubble generator. In certain embodiments, the bubble generator may act as a gas inlet for the at least one stage. In operation, the at least one stage of the bubble column condenser may further comprise a liquid layer comprising an amount of a condensable fluid in liquid phase (e.g., at least a portion of a cooling liquid stream).

In some embodiments, the at least one stage may further comprise a vapor distribution region positioned adjacent the liquid layer (e.g., above the liquid layer). The vapor distribution region refers to the space within the stage throughout which vapor is distributed (e.g., the portion of the stage not occupied by the liquid layer). The vapor distribution region may, in certain cases, advantageously damp out flow variations created by random bubbling by allowing a gas to redistribute evenly across the cross section of the dehumidifier. Additionally, in the free space of the vapor distribution region, large droplets entrained in the gas may have some space to fall back into the liquid layer before the gas enters the subsequent stage. In some embodiments, the vapor distribution region is positioned between two liquid layers of two consecutive stages. The vapor distribution region may serve to separate the two consecutive stages, thereby increasing the thermodynamic effectiveness of the bubble column condenser by keeping the liquid layers of each stage separate. In some embodiments, each stage of a plurality of stages of the bubble column condenser comprises a bubble generator, a liquid layer, and a vapor distribution region positioned adjacent the liquid layer.

In some embodiments, the bubble column condenser is configured to receive a humidified gas stream (e.g. humidified gas stream 222) through a main dehumidifier gas inlet as a dehumidifier gas inlet stream. The dehumidifier gas inlet stream may flow through the bubble generator of the at least one stage of the condenser, thereby forming a plurality of bubbles of the heated, at least partially humidified gas. In some cases, the gas bubbles flow through the liquid layer of the at least one stage of the condenser. As the gas bubbles directly contact the liquid layer, which may have a lower temperature than the gas bubbles, heat and/or mass (e.g., condensable fluid) may be transferred from the gas bubbles to the liquid layer via a condensation (e.g., dehumidification) process, thereby forming a at least partially dehumidified, cooled at least partially dehumidified dehumidifier gas outlet stream (e.g. dehumidified gas stream 242) and a dehumidifier liquid outlet stream comprising the condensable fluid in liquid phase (e.g. condensate-containing stream 244). In certain embodiments, the condensable fluid is water, and the dehumidifier gas outlet stream is lean in water vapor relative to the dehumidifier gas inlet stream received from the main dehumidifier gas inlet. In some embodiments, bubbles of the cooled, at least partially dehumidified gas exit the liquid layer and recombine in the vapor distribution region, and the cooled, at least partially dehumidified gas is substantially evenly distributed throughout the vapor distribution region. The dehumidifier gas outlet stream may exit the bubble column condenser through the dehumidifier gas outlet, and the dehumidifier liquid outlet stream may exit the bubble column condenser through the dehumidifier liquid outlet.

In embodiments, the bubble column condenser comprises a plurality of stages, and one or more stages of the plurality of stages comprise a liquid layer comprising an amount of a condensable fluid in liquid phase. In some embodiments relating to multi-stage dehumidifiers, the temperature of a liquid layer of a first stage (e.g., the topmost stage in a vertically arranged dehumidifier) may be lower than the temperature of a liquid layer of a second stage (e.g., a stage positioned below the first stage in a vertically arranged dehumidifier), which may be lower than the temperature of a liquid layer of a third stage (e.g., a stage positioned below the second stage in a vertically arranged dehumidifier). In some embodiments, each stage in a multi-stage dehumidifier operates at a temperature above that of the previous stage (e.g., the stage above it, in embodiments comprising vertically arranged dehumidifiers).

The presence of multiple stages within the bubble column condenser may, in some cases, advantageously result in increased dehumidification of a gas stream. In some cases, the presence of multiple stages may advantageously lead to higher recovery of a condensable fluid in liquid phase. For example, the presence of multiple stages may provide numerous locations where the gas may be dehumidified (e.g., treated to recover the condensable liquid). That is, the gas may travel through more than one liquid layer in which at least a portion of the gas undergoes dehumidification (e.g., condensation). In addition, the presence of multiple stages may increase the difference in temperature between a liquid stream at an inlet and an outlet of a dehumidifier. For example, the use of multiple stages can produce a condensate-containing stream having increased temperature relative to the cooling liquid stream. This may be advantageous in systems where heat from a liquid stream (e.g., condensate-containing stream 244 in FIG. 2) is transferred to a separate stream (e.g., second heating device influent stream 252 in FIG. 2) within the system. In such cases, the ability to produce a condensate-containing stream with a relatively high temperature can increase the energy effectiveness of the system. Additionally, the presence of multiple stages may enable greater flexibility for fluid flow within a system (e.g., injection gas streams to intermediate dehumidifier stages).

In some embodiments, an influent liquid stream (e.g. cooling liquid stream 240) enters the first stage of the bubble column dehumidifier through a liquid inlet, and forms a first-stage liquid layer. Direct contact with partially dehumidified gas bubbles traveling through the first-stage liquid layer of may heat and transfer condensate to the liquid therein. In some embodiments, the heated condensate-bearing product of the first-stage liquid layer may flow to the second stage of the bubble column dehumidifier to form a second-stage liquid layer. Direct contact with partially dehumidified gas bubbles traveling through the second-stage liquid layer may further heat and transfer additional condensate to the liquid therein. In some embodiments, the further heated condensate-bearing product of the second-stage liquid layer may flow to an additional stage to form a liquid layer therein. In other embodiments, the further heated condensate-bearing product may be discharged from the bubble column humidifier as a condensate-containing stream (e.g. condensate-containing stream 244).

It should be noted that the inventive systems and methods described herein are not limited to those including a bubble column condenser and that other types of dehumidifiers may be used in some embodiments. For example, the dehumidifier may be a surface condenser, a spray tower, or a packed bed tower. In certain cases, the dehumidifier may comprise a surface (e.g., a metal surface) in contact with a gas stream comprising a condensable fluid in vapor phase.

In some embodiments, the dehumidifier (e.g., bubble column condenser) is configured to have a relatively high condensation rate. In certain cases, for example, the dehumidifier has a condensation rate of at least about 80 m3/day [about 503.1 barrels/day], at least about 90 m3/day [566.0 barrels/day], at least about 100 m3/day [628.9 barrels/day], at least about 125 m3/day [786.2 barrels/day], at least about 150 m3/day [943.4 barrels/day], at least about 175 m3/day [1,101 barrels a day], at least about 200 m3/day [1258 barrels/day], at least about 225 m3/day [1,415 barrels/day], at least about 250 m3/day [1,572 barrels/day], at least about 275 m3/day [1,730 barrels/day], at least about 300 m3/day [1,887 barrels/day], at least about 400 m3/day [2,516 barrels/day], at least about 500 m3/day [3,145 barrels/day], at least about 600 m3/day [3,774 barrels/day], at least about 700 m3/day [4,403 barrels/day], or at least about 800 m3/day [5,031 barrels/day]. In some embodiments, the dehumidifier has a condensation rate of about 80 m3/day [503.1 barrels/day] to about 800 m3/day [5,031 barrels/day], about 90 m3/day [566.0 barrels/day] to about 800 m3/day [5,031 barrels/day], about 100 m3/day [628.9 barrels/day] to about 800 m3/day [5,031 barrels/day], about 125 m3/day [786.2 barrels/day] to about 800 m3/day [5,031 barrels/day], about 150 m3/day [943.4 barrels/day] to about 800 m3/day [5,031 barrels/day], about 175 m3/day [1,101 barrels a day] to about 800 m3/day [5,031 barrels/day], about 200 m3/day [1258 barrels/day] to about 800 m3/day [5,031 barrels/day], about 225 m3/day [1,415 barrels/day] to about 800 m3/day [5,031 barrels/day], about 250 m3/day [1,572 barrels/day] to about 800 m3/day [5,031 barrels/day], about 275 m3/day [1,730 barrels/day] to about 800 m3/day [5,031 barrels/day], about 300 m3/day [1,887 barrels/day] to about 800 m3/day [5,031 barrels/day], about 400 m3/day [2,516 barrels/day] to about 800 m3/day [5,031 barrels/day], about 500 m3/day [3,145 barrels/day] to about 800 m3/day [5,031 barrels/day], about 600 m3/day [3,774 barrels/day] to about 800 m3/day [5,031 barrels/day], or about 700 m3/day [4,403 barrels/day] to about 800 m3/day [5,031 barrels/day]. The condensation rate of the dehumidifier may be obtained by measuring the total liquid output volume of the dehumidifier (e.g., the volume of all dehumidifier liquid outlet streams) over a time period (e.g., one day) and subtracting the input volume of the dehumidifier (e.g., the volume of all dehumidifier liquid inlet streams) over the time period.

According to some embodiments, the condensate-containing stream has a relatively low salinity. In certain embodiments, the salinity of the condensate-containing stream is about 0.5% or less, about 0.2% or less, about 0.1% or less, about 0.05% or less, about 0.02% or less, about 0.01% or less, about 0.005% or less, about 0.002% or less, or about 0.001% or less. In some cases, the salinity of the condensate-containing stream is substantially zero (e.g., not detectable). In certain cases, the salinity of the condensate-containing stream is in the range of about 0% to about 0.5%, about 0% to about 0.2%, about 0% to about 0.1%, about 0% to about 0.05%, about 0% to about 0.02%, about 0% to about 0.01%, about 0% to about 0.005%, about 0% to about 0.002%, or about 0% to about 0.001%.

In some embodiments, the salinity of the condensate-containing stream is substantially less than the salinity of the cooling liquid stream received by the dehumidifier. In some cases, the salinity of the condensate-containing stream is at least about 0.5%, about 1%, about 2%, about 5%, about 10%, about 15%, or about 20% less than the salinity of the cooling liquid stream.

In some embodiments, the humidifier-dehumidifier system has a relatively high production rate (e.g., amount of substantially pure water produced per unit time). In certain cases, the system has a production rate of at least about 80 m3/day [about 503.1 barrels/day], at least about 90 m3/day [566.0 barrels/day], at least about 100 m3/day [628.9 barrels/day], at least about 125 m3/day [786.2 barrels/day], at least about 150 m3/day [943.4 barrels/day], at least about 175 m3/day [1,101 barrels a day], at least about 200 m3/day [1258 barrels/day], at least about 225 m3/day [1,415 barrels/day], at least about 250 m3/day [1,572 barrels/day], at least about 275 m3/day [1,730 barrels/day], at least about 300 m3/day [1,887 barrels/day], at least about 400 m3/day [2,516 barrels/day], at least about 500 m3/day [3,145 barrels/day], at least about 600 m3/day [3,774 barrels/day], at least about 700 m3/day [4,403 barrels/day], or at least about 800 m3/day [5,031 barrels/day]. In some embodiments, the humidifier-dehumidifier system has a production rate in the range of about 80 m3/day [503.1 barrels/day] to about 800 m3/day [5,031 barrels/day], about 90 m3/day [566.0 barrels/day] to about 800 m3/day [5,031 barrels/day], about 100 m3/day [628.9 barrels/day] to about 800 m3/day [5,031 barrels/day], about 125 m3/day [786.2 barrels/day] to about 800 m3/day [5,031 barrels/day], about 150 m3/day [943.4 barrels/day] to about 800 m3/day [5,031 barrels/day], about 175 m3/day [1,101 barrels a day] to about 800 m3/day [5,031 barrels/day], about 200 m3/day [1258 barrels/day] to about 800 m3/day [5,031 barrels/day], about 225 m3/day [1,415 barrels/day] to about 800 m3/day [5,031 barrels/day], about 250 m3/day [1,572 barrels/day] to about 800 m3/day [5,031 barrels/day], about 275 m3/day [1,730 barrels/day] to about 800 m3/day [5,031 barrels/day], about 300 m3/day [1,887 barrels/day] to about 800 m3/day [5,031 barrels/day], about 400 m3/day [2,516 barrels/day] to about 800 m3/day [5,031 barrels/day], about 500 m3/day [3,145 barrels/day] to about 800 m3/day [5,031 barrels/day], about 600 m3/day [3,774 barrels/day] to about 800 m3/day [5,031 barrels/day], or about 700 m3/day [4,403 barrels/day] to about 800 m3/day [5,031 barrels/day].

In some embodiments, the humidifier-dehumidifier system further comprises a second heating device, which may be in the form of a heat exchanger. In certain cases, the second heating device/heat exchanger facilitates transfer of heat from a fluid stream exiting the dehumidifier (e.g., a condensate-containing stream) to a fluid stream entering the system and/or a fluid stream recirculating through the system (e.g., a feed stream to the humidifier feed stream flow path). For example, the second heating device/heat exchanger may advantageously allow energy to be recovered from a condensate-containing stream and be used to pre-heat the feed stream prior to entry of the feed stream into the first heating device. The presence of the second heating device in the form of a heat exchanger to recover energy from the condensate-containing stream may, therefore, reduce the amount of heat required to be applied to the feed stream. In some embodiments, the system can be configured such that at least a portion of the cooled condensate-containing stream can be returned to the dehumidifier through a dehumidifier liquid inlet (e.g. as a cooling liquid stream) and be re-used as a liquid to form liquid layers in one or more stages of the dehumidifier.

Temperature-matched influent injection, according to some embodiments, may, be beneficial to a system comprising a humidifier and a dehumidifier (e.g. a humidifier-dehumidifier system). In embodiments in which heat is transferred in a second heating device from a liquid stream being recirculated through a dehumidifier to a liquid stream being recirculated through a humidifier, injecting an influent stream into the humidifier recirculate stream at a location downstream of the second heating device may reduce fluctuations in the temperature of the dehumidifier recirculate stream. For example, a substantial fluctuation in the temperature and/or flow rate of injected influent stream 210, as shown in FIG. 2, may directly affect the temperature and/or flow rate of combined liquid stream 214. In some embodiments, the combined liquid stream is heated to a specific temperature by a combined stream heating device, and the fluctuation is eliminated. However, in other embodiments, the affected combined stream may subsequently flow to humidifier 202, to affect the thermal conditions therein, resulting in a change in temperature and condensable fluid content of concentrate stream 218 and humidified gas stream 222, which may then flow to the dehumidifier. Thus, in such embodiments, fluctuations in the injected influent stream may transmitted to the dehumidifier primarily through the gas stream. In comparison, an influent stream injected upstream of the second heating device, in an otherwise identical system configuration, would transmit fluctuations to the dehumidifier through the cooling liquid stream. Without wishing to be bound to a particular theory, it is believed that the large thermal capacity, physical volume, and greater quantity of thermal energy carried by the humid air steam may serve to damp out thermal oscillations transmitted thereby.

In some embodiments, the relative mass flow rates of gas and liquid streams in the humidifier and/or dehumidifier may be determined by calculating a heat capacity rate ratio (HCR). The HCR can be calculated by taking the differences between the changes in the specific enthalpy rates that would be reached by each fluid in the humidifier and/or dehumidifier if, starting at their respective influent conditions, each fluid reached the other fluid's temperature at their respective effluent locations. For the gas stream, this idealized enthalpy rate change calculation additionally requires the calculation of an idealized humidity that would be reached. As is known in the art, mass transfer between liquids and gasses occurs until the vapor pressure of a liquid is equal to the partial pressure of the gas. Because the heat capacity ratio is calculated using idealized effluent conditions effectively based on an infinite-sized device, the idealized humidity ratio is this equilibrium point established above. The HCR is equal to the quotient of the idealized enthalpy rate change of the hotter fluid and the idealized enthalpy rate change of the cooler fluid. According to certain embodiments, the effectiveness of a humidifier and/or dehumidifier is maximized when relative mass flow rates of gas and liquid streams are established such that the HCR is approximately equal to 1.

In some embodiments, the HCR is relatively close to 1. For example, the HCR may be smaller or greater than 1 by about 1%, by about 2%, by about 5%, or in some cases by about 10%. In some embodiments, the amount by which the HCR is smaller or greater than 1 ranges from about zero to about 1%, from about 1% to about 2%, from about 2% to about 5%, or from about 5% to about 10%.

In some embodiments, the humidifier comprises one or more gas extraction outlets located between the gas inlet and the gas outlet. In some such embodiments, partially humidified and gas may be extracted from the humidifier through one or more gas extraction outlet. In some embodiments, the dehumidifier comprises one or more corresponding gas injection inlets each fluidically connected to a corresponding gas extraction outlet. In some such embodiments, the partially humidified gas extracted from the humidifier may be injected into the dehumidifier to combine with partially dehumidified gas therein. The locations of the gas extraction outlets and/or gas injection inlets may be selected such that, at the gas injection location, the temperature of injected gas is approximately equal to the temperature of the partially dehumidified gas with which the injected gas is mixed. The flow rate of the extracted gas may be determined such that the HCR of the fluids in the sections of the humidifier and/or dehumidifier bounded by the gas extraction outlet and/or gas extraction inlet and the nearest other gas inlet and/or outlet is approximately equal to 1.

In some embodiments, the system comprises one or more optional cooling devices. The one or more optional cooling devices may be configured to cool a liquid stream. In some embodiments, the cooling device(s) may be fluidically connected to the dehumidifier. The cooling devices may, in some cases, also be fluidically connected to the second heating device. In certain embodiments, the cooling device(s) may be arranged such that a liquid stream (e.g. cooling liquid stream 240 in FIG. 2) is cooled in the cooling device(s) prior to entering the dehumidifier.

In some embodiments, the dehumidified gas stream exiting the dehumidifier gas outlet is directed the main humidifier gas inlet, such that at least a portion of the influent gas stream received by the main humidifier gas inlet comprises at least a portion of the dehumidified gas stream. This configuration is typically called a “closed gas” configuration because at least a portion of the gas does not leave the system. In some embodiments, the influent gas stream comprises the entirety of the dehumidified gas stream. In some embodiments, the influent gas stream additionally comprises a portion of make-up gas, wherein the make-up gas is essentially comprised of the same non-condensable gas or mixture of non-condensable gasses that comprises the non-condensable gas portion of the dehumidified gas stream. Such a configuration may be particularly beneficial in embodiments where the non-condensable gas differs from the ambient gas (e.g. air) in the vicinity of the system. For example, a “closed gas” configuration may be particularly beneficial to systems where the non-condensable gas portion of the dehumidified gas stream is nitrogen.

Some embodiments comprise an influent injection system. In some embodiments, the temperature of the influent stream injected into a humidifier feed stream flow path to combine with a feed stream, may be time-variant. In some such embodiments, the temperature of the injected influent stream may vary such that, at certain times, the temperature of the injected influent stream is closest to the temperature of the feed stream at a first location along the humidifier feed stream flow path (e.g. downstream of a first heating device), and at other times, closest to the temperature of the feed stream at a second location (e.g. upstream of the first heating device). In such embodiments, the most beneficial location to inject the influent may vary. In some embodiments, the humidifier feed stream flow path comprises a plurality of injection junctions located at different positions along the flow path. According to some such embodiments, an influent injection system is configured to inject the influent stream into an injection junction located in a position on the humidifier feed stream flow path at which the temperature of the feed stream is closest to the temperature of the injected influent stream.

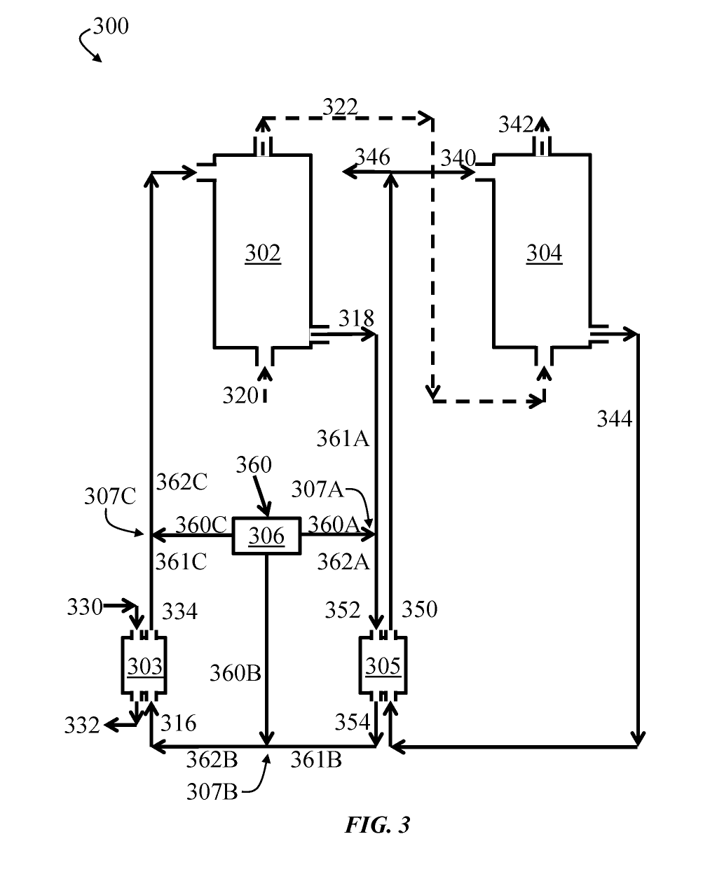

FIG. 3 shows an exemplary humidifier-dehumidifier system comprising a dehumidifier and an influent injection system comprising a plurality of injection junctions. The exemplary humidifier-dehumidifier system 300 includes humidifier 302, first heating device 303, dehumidifier 304, second heating device 305, influent injection system 306, and a plurality of injection junctions indicated as 307A, 307B, and 307C. Influent injection system 306 is fluidically connected to a source of influent stream 360, as well as a plurality of influent injection conduits, shown in FIG. 3 as conveying injection streams 360A, 360B, and 360C. Each injection conduit is fluidically connected to a corresponding influent injection junction, respectively 307A, 307B, and 307C. Influent injection junction 307A is fluidically connected to and downstream of a first fluidic pathway outlet of first heating device 303 and fluidically connected to and upstream of a liquid inlet of humidifier 302. Influent injection junction 307B is fluidically connected to and upstream of a first fluidic pathway inlet of first heating device 303 and fluidically connected to and downstream of a first fluidic pathway outlet of second heating device 305. Influent injection junction 307C is fluidically connected and upstream of to a first fluidic pathway inlet of second heating device 305 and fluidically connected to and downstream of a liquid outlet of humidifier 302. Humidifier 302 comprises a gas inlet and a main gas outlet, in addition to the liquid inlet fluidically connected to influent injection junction 307A, and the liquid outlet fluidically connected to influent injection junction. The gas inlet of humidifier 302 is shown in FIG. 3 as the inlet receiving gas stream 320, and the main gas outlet is shown as transmitting gas stream 322. Dehumidifier 304 comprises a main gas inlet fluidically connected to the main gas outlet of humidifier 302, a gas outlet, shown in FIG. 3 as transmitting gas stream 342, a liquid inlet fluidically connected to a second fluidic pathway outlet of second heating device 305, and a liquid outlet fluidically connected to a second fluidic pathway inlet of second heating device 305. First heating device 303 may comprise an optional second fluidic pathway inlet, shown as receiving stream 330, and an optional second fluidic pathway outlet, shown as transmitting stream 332.

In operation, humidifier 302, first heating device 303, dehumidifier 304, and second heating device 305 may function similarly to humidifier 102, first heating device 103, dehumidifier 204, and second heating device 205 described in relation to FIG. 1 and FIG. 2. In addition, influent injection system 306 may receive an influent stream from source 360. Based on the temperature of the stream, the influent injection system may direct that received stream to an influent injection junction selected from a plurality of injection junctions, which, in the exemplary humidifier-dehumidifier system 300, include influent injection junctions 307A, 307B, and 307C. At the selected influent injection junction, the injected influent stream (e.g. injected influent stream 360A, 360B, and/or 360C) combines with a feed stream (e.g. feed stream 361A, 361B, and/or 361C) to form a combined liquid stream (e.g. combined liquid stream 362A, 362B, and/or 362C) comprising the feed stream and the injected influent stream.

Feed stream 361 may enter a humidifier feed stream flow path from a source, which in some embodiments comprises at least a portion of concentrate stream transmitted by the humidifier liquid outlet (e.g. concentrate stream 318). The humidifier flow path, as described in more detail previously, comprises all fluidically connected components wettable by a feed stream in a continuous flow path from the source of the feed stream to the humidification zone of a humidifier. In exemplary humidifier-dehumidifier system 300, the humidifier feed stream flow path comprises the conduit shown transmitting feed stream 361C, influent injection junction 307C, the conduit disposed between injection junction 307C and second heating device 305, the wettable components of a first fluidic pathway of second heating device 305, the conduit disposed between second heating device 305 and influent injection junction 307B, the conduit disposed between influent injection junction 307B and first heating device 303, the wettable components of a first fluidic pathway of first heating device 303, the conduit disposed between first heating device 303 and influent injection junction 307A, influent injection junction 307A, the conduit disposed between influent injection junction 307A and the liquid inlet of humidifier 302, as well as the wettable components of humidifier 302 upstream of the humidification zone of the humidifier.

Within the humidifier feed stream flow path, the feed stream and/or a stream comprising the feed stream may be heated in a series of steps. The humidifier feed stream flow may comprise a plurality of injection junctions, disposed between the heating steps, into which an influent stream may be injected. The injection junction into which the influent stream is injected may be selected such that the temperature of the feed stream most closely matches the temperature of the feed stream entering the selected junction. In exemplary humidifier-dehumidifier system 300, feed stream 361C may be combined with injected influent stream 360C, depending on temperature conditions in the influent and the humidifier feed stream flow path. The combination of the two streams may produce combined stream 362C. The stream resulting from the combination or lack thereof may enter a first fluidic flow pathway (e.g. through the first fluidic pathway inlet) of heating device 305 as preheater influent stream 352. Within heating device 305, heat may be transferred from a fluid stream flowing through a second fluidic pathway to preheater influent stream 352, producing preheated stream 354. Preheated stream 354 may enter influent injection junction 307B as feed stream 361B. Depending on temperature conditions in the influent stream and the humidifier feed stream flow path, feed stream 361B may be combined with injected influent stream 360B within influent injection junction 307B to form combined liquid stream 362B, which may enter a first fluidic pathway (e.g. through the first fluidic pathway inlet) of first heating device 303 as heater influent stream 316. Within heating device 305, heat may be transferred from a fluid stream flowing through an optional second fluidic pathway to heater influent stream 316, to produce heated stream 334. Heating influent stream 330 may enter an optional second fluidic pathway of heating device 303 (e.g. through an optional second fluidic pathway inlet) at a relatively high temperature compared to heater influent stream 316 such that heat is transferred from heating influent stream 330 to heater influent stream 316 to produce cooled heating stream 332 from heating influent stream 330. Heated stream 334 may enter influent injection junction 307A as feed stream 361A. Depending on temperature conditions in the influent and the humidifier feed stream flow path, feed stream 361A may be combined with injected influent stream 360A within influent injection junction 307A to form combined liquid stream 362A. Combined liquid stream 362A may enter humidifier 302 as combined humidifier influent stream 314. Combined humidifier influent stream 314 may comprise a combination of feed stream 361A and injected influent stream 360A, a combination of feed stream 361B and injected influent stream 360B, and/or a combination of feed stream 361C and injected influent stream 360C, depending on temperature conditions in the influent stream and the humidifier feed stream flow path.

In some non-limiting embodiments, the influent stream may be injected into a single influent injection junction. In other embodiments, at least a portion of influent stream may be injected into a first junction and at least another portion may be injected into a second junction. For example, in some such embodiments, the influent injection system may direct an influent stream to a selected influent injection system by controlling through a plurality of influent injection conduits with a series of air operated valves. During the opening of a first valve and the closing of a second valve, portions of the influent stream may flow to more than one influent injection junction. In some embodiments, the injection junction that receives the greatest portion of the influent stream has also receives a feed stream that has a temperature closer to the temperature of the influent stream than the temperature of a feed stream received by any other injection junction.

In some embodiments, the influent injection system is configured to direct one or more sources of influent stream to one or more injection junctions. In some embodiments, the influent injection system may fluidically connect the one or more sources to each injection junction. For example, the influent injection system may comprise a header fluidically connected to the one or more sources, and a plurality of influent injection conduits each fluidically connected to the header and to respective influent injection junctions such that each of the one or more sources may be directed to each injection junction. In some embodiments, the injection system may fluidically connect one or more sources of influent stream to one or more respective influent injection junctions, such that no mixing of streams flowing from the one or more sources occurs. In some embodiments, the influent injection system fluidically connects one or more sources of a first set of sources to each injection junction of a first set of injection junctions, and fluidically connects one or more sources of a second set of sources to respective injection junctions of a second set of injection junctions. For example, the influent injection system may comprise a header fluidically connected to one or more flue gas desulfurization wastewater treatment systems and fluidically connected to one or more injection junctions of a first set of injection junctions, in addition to conduit fluidically connected a source of cooling tower blowdown wastewater to and a single influent injection junction not included in the first set of injection junctions.

The configuration of the influent injection to direct one or more sources of influent stream to one or more injection junctions by any known in the art. In some embodiments, the configuration to direct influent streams may be a permanent construction, and the direction may be by way of the design of the construction. For example, a first source of influent stream may be connected to a first injection junction, and a second source of influent stream may be connected to a second injection junction such that an influent stream from the first source is directed to flow exclusively to the first junction and an influent stream from the second source is directed to flow exclusively to the second junction. Such a configuration may be beneficial if, for example, each source of influent supplies the respective influent stream at a constant temperature. In some embodiments, the configuration to direct influent streams may allow selection of an injection junction. For example, the one or more sources of influent stream may be fluidically connected to a header, and the header may be fluidically connected to a plurality of injection junctions by respective conduits each comprising a closable valve, such that positions of the closable valves (e.g. open or closed) direct an influent stream to a selected injection junction.

In some embodiments, the injection junction into which the influent is injected can be selected from a plurality of injection junctions such that the selected junction receives a feed stream with a temperature closer to the temperature of the influent stream than any other feed stream received by any other injection junction. The selection of the injection junction may be by any method suitable to match the temperature of the influent with the temperature of the received feed steam. In some embodiments, the selection is automated and the influent injection system comprises a computer. In some such embodiments, the temperature of at least one of the influent stream and/or of at least one of the feed streams received by each respective injection junction are measured directly and/or indirectly (e.g. by calculating a heat balance on a heat exchanger to determine the temperature of effluent streams), the measurements are communicated to the computer which performs a calculation to determine which feed stream temperature is closest to the temperature of the influent to select the injection junction. In some embodiments, the measurement of each temperature may not be required. For example, certain streams may have relatively constant temperatures during operation or are relatively invariant due to a process acting on them (e.g. pure water boils always at 100° C. at atmospheric pressure), and thus the temperature of those streams may be sufficiently anticipated without the need for measurement. In some embodiments, the selection of the influent injection junction may be performed by an operator controlling the influent injection system. In other embodiments, the selection of the injection junction may by permanent design. For example, a first source may provide an influent stream at a first constant temperature, and a second source may provide an influent stream at a second constant temperature. In such cases, the first source may be directed to a first injection junction by a permanent construction (e.g. a conduit) at which the received feed stream temperature is closest to the first temperature, and the second source may be directed to a second injection junction by a permanent construction at which the received feed stream temperature is closest to the second temperature.

In some embodiments, the influent injection junction is selected such that the difference in temperature between the injected influent stream and a feed stream entering the selected injection junction is relatively small. For example, the difference in magnitude between the temperature of feed stream entering the injection junction into which the influent stream is injected and the temperature of the injected influent stream may be less than about 30° C. [54° F.], less than about 20° C. [36° F.], less than about 15° C. [27° F.], less than about 10° C. [18° F.], less than about 5° C. [9° F.], less than about 2° C. [3.6° F.], less than about 1° C. [1.8° F.]. In some cases, the injected influent stream may be substantially the same temperature as the feed stream entering the influent injection junction.

In certain embodiments, the temperature of the influent stream at the selected injection junction is substantially different from the temperature of a feed stream received by any injection junction other than the selected one. For example, the smallest difference in magnitude between the temperature of injected influent stream and the temperature of the feed stream received by an injection junction other than the selected injection junction may be as great as about 10° C. [18° F.], as great as about 15° C. [27° F.], as great as about 20° C. [36° F.], as great as about 30° C. [54° F.], as great as about 40° C. [72° F.], as great as about 50° C. [90° F.], as great as about 75° C. [135° F.], or in some extreme cases, as great as about 100° C. [180° C.]. In some embodiments, the smallest difference in magnitude between the temperature of the injected influent stream and a feed stream received by an injection junction other than the selected injection junction may be in the range of about 10° C. [18° F.] to about 15° C. [27° F.], about 15° C. [27° F.] to about 30° C. [54° F.], about 30° C. [54° F.] to about 50° C. [90° F.], about 50° C. [90° F.] to about 75° C. [135° F.], about 75° C. [135° F.] to about 100° C. [180° F.].

In some embodiments, the influent injection system is fluidically connected to a plurality of injection junctions located along the humidifier feed stream flow path, including at least a first injection junction (e.g. influent injection junction 307A in FIG. 2). In certain embodiments, the first injection junction may be located downstream of a first heating device (e.g. first heating device 303) and upstream of a humidification zone of a humidifier (humidifier 302, for example). In some embodiments, the first injection junction may be integrated with a liquid inlet of the humidifier or an outlet of the first heating device, such as the first fluidic pathway outlet. In certain embodiments, the first injection junction is located within the humidifier. For example, the humidifier may comprise a liquid distribution system that is integrated with the first injection junction. Per other embodiments, the first injection junction is coupled with the boundary of the humidification zone. For example, the injected influent stream and the feed stream may be separately fed to the humidification zone via separate liquid distributors, such that they cross the boundary of the humidification zone simultaneously at same location, resulting in a combined liquid stream that enters the humidification zone.

In some embodiments, the influent injection system is fluidically connected to a plurality of injection junctions comprising at least the first injection junction, and a second injection junction. In certain embodiments, the second injection junction may be located upstream of a first heating device (e.g. first heating device 303). In some embodiments, the second injection junction may be located downstream of a second heating device. In certain embodiments, the second injection junction may be integrated with a liquid inlet or outlet of a heating device.

In some embodiments, the influent injection system is fluidically connected to a plurality of injection junctions comprising at least a first injection junction, a second injection junction, and a third injection junction. According to some embodiments, the third injection junction is located upstream of a second heating device. In certain cases, the third influent injection junction is located downstream of a liquid outlet of the humidifier.

In some embodiments, the influent injection system may receive one or more influent streams that vary in temperature and/or flow rate. In some cases, the variance in temperature and/or flow rate may be on the order of seconds, minutes, hours, days, or weeks. In some cases, the variance of temperature and/or flow rate of the influent may be due a change in influent source. For example, the humidifier system comprising the influent injection system may be a mobile system configured to be transportable to different sources of wastewater of varying temperatures.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A humidification method, comprising:
flowing a first liquid stream comprising water and a dissolved salt, the first liquid stream having a first temperature, through a first heating device, wherein the first liquid stream is heated to a second temperature within the first heating device to form a heated liquid stream;
combining the heated liquid stream with a second liquid stream comprising water and a dissolved salt, the second liquid stream having a third temperature, to form a combined liquid stream;
directly contacting the combined liquid stream with an influent gas stream to transfer to heat and mass from the combined liquid stream to the influent gas stream within a humidifier, wherein the heat and mass transfer produces a humidified gas stream enriched in water vapor with respect to the influent gas stream;
wherein, the difference between the first temperature and the third temperature is greater in magnitude than the difference between the second temperature and the third temperature.

2. The method according to claim 1, further comprising flowing the combined liquid stream through a second heating device prior to directly contacting the combined liquid stream with the influent gas stream, and heating the combined liquid stream to a fourth temperature within the second heating device, wherein the difference between the third temperature and the fourth temperature is greater in magnitude than the difference between the second temperature and the third temperature.

3. The method according to claim 1, further comprising flowing the first liquid stream through a second heating device prior to flowing the first liquid stream through the first heating device, and heating the first liquid stream from a fourth temperature to the first temperature within the second heating device, wherein the difference between the third temperature and the fourth temperature is greater in magnitude than the difference between the second temperature and the third temperature.

4. The method according to claim 1, wherein the third temperature is between 50° C. and the ambient pressure boiling point temperature of the first stream.

5. The method according to claim 1, wherein the second liquid stream comprises a wastewater stream produced from an industrial process in which steam is generated or condensed at about or below ambient pressure.

6. (canceled)

7. The method according to claim 1, wherein the first liquid stream comprises at least a portion of a concentrated remnant of the combined liquid stream resulting from the transfer of heat and mass therefrom in the humidifier.

8-10. (canceled)

11. The method according to claim 1, further comprising directing the humidified gas stream into a gas inlet of a dehumidifier; within the dehumidifier, removing heat from the humidified gas stream to cause condensation of at least a portion of the water vapor to form a dehumidified gas stream deficient in water vapor with respect to the humidified gas stream and a condensate-containing stream comprising the condensed vapor from the humidified gas stream; removing the dehumidified gas stream and condensate-containing stream from the dehumidifier.

12-14. (canceled)

15. The method according to claim 11, wherein at least a portion the heat removed from the humidified gas stream in the dehumidifier to cause condensation of at least a portion of the water vapor component is transferred to a liquid stream comprising the first liquid stream.

16. The method according to claim 15, wherein the at least a portion of the heat that is removed from the humidified gas stream in the dehumidifier is transferred to a cooling liquid stream to form a hot condensate-containing stream, the method further comprising flowing at least a portion of the condensate-containing stream from the dehumidifier to a first fluidic pathway of a heat exchanger and flowing a liquid stream comprising the first liquid stream to a second fluidic pathway of the heat exchanger; transferring, within the heat exchanger, heat from the at least a portion of the condensate-containing stream to the liquid stream comprising the first liquid stream to form a cooled stream; and reintroducing at least a portion of the cooled stream to the dehumidifier as the cooling liquid stream.

17. The method according to claim 11, wherein at the influent gas stream comprises at least a portion of the dehumidified gas stream removed from the dehumidifier.

18. A method of operating a humidifier, the method comprising;
flowing a first liquid stream comprising water and a dissolved salt into a humidification flow path comprising a first heating device and a humidification region of a humidifier, located downstream of the first heating device, as well as a plurality of injection junction;
wherein, the plurality of injection junctions includes at least a first injection junction located upstream of the first heating device and a second injection junction located upstream of the humidification region of the humidifier and downstream of the first heating device;
heating a fluid comprising the first liquid stream in the first heating device, wherein the fluid comprising the first liquid stream is heated;
injecting a second liquid stream comprising water and a dissolved salt into one of the injection junctions to form a combined liquid stream comprising the first liquid stream and the second liquid stream;
wherein, at the injection junction into which the second liquid stream is injected, the first liquid stream has a temperature that is closer to the temperature of the second liquid stream than that of any stream entering any other injection junction from the humidification flow path;
within the humidification region of the humidifier, directly contacting the combined liquid stream with an influent gas stream to transfer to heat and mass from the combined liquid stream to the influent gas stream, wherein the heat and mass transfer produces a humidified gas stream enriched in water vapor with respect to the influent gas stream.

19. The method according to claim 18, further comprising heating a liquid stream comprising the first liquid stream in a second heating device, wherein the second heating device is located upstream of the first heating device in the humidification flow path.

20. The method according to claim 19, wherein the plurality of injection junctions further comprises a third injection junction located upstream of the second heating device in the humidification flow path, and the first injection junction is located downstream of the second heating device.

21. The method according to claim 18, further comprising heating the combined liquid stream in a second heating device, wherein the second heating device is located downstream of the second injection junction and upstream of the humidification region in the humidification flow path.

22. The method according to claim 18, wherein the temperature of the second liquid stream is between 50° C. and the ambient pressure boiling point of second liquid stream.

23. The method according to claim 18, wherein the second liquid stream comprises a wastewater stream produced from an industrial process in which steam is generated or condensed at about or below ambient pressure.

24. (canceled)

25. The method according to claim 18, wherein the first liquid stream comprises at least a portion of a concentrated remnant of the combined liquid stream resulting from the transfer of heat and mass therefrom in the humidifier.

26-28. (canceled)

29. The method according to claim 18, further comprising directing the humidified gas stream into a gas inlet of a dehumidifier; within the dehumidifier, removing heat from the humidified gas stream to cause condensation of at least a portion of the water vapor to form a dehumidified gas stream deficient in water vapor with respect to the humidified gas stream and a condensate-containing stream comprising the condensed vapor from the humidified gas stream; removing the dehumidified gas stream and condensate-containing stream from the dehumidifier.

30-32. (canceled)

33. The method according to claim 29, wherein at least a portion of the heat removed from the humidified gas stream in the dehumidifier to cause condensation of at least a portion of the water vapor component is transferred to a liquid stream comprising the first liquid stream within a heat exchanger.

34. The method according to claim 33, wherein the at least a portion heat that is removed from the humidified gas stream in the dehumidifier is transferred to a cooling liquid stream to form a hot condensate-containing stream, the method further comprising flowing at least a portion of the condensate-containing stream from the dehumidifier to a first fluidic pathway of a heat exchanger and flowing a liquid stream comprising the first liquid stream to a second fluidic pathway of the heat exchanger; transferring, within the heat exchanger, heat from the at least a portion of the condensate-containing stream to the liquid stream comprising the first liquid stream to form a cooled stream; and reintroducing at least a portion of the cooled stream to the dehumidifier as the cooling liquid stream.

35. (canceled)
